(19) United States
(12) Patent Application Publication
(10) Pub. No.: US 2025/0217214 A1
(43) Pub. Date: Jul. 3, 2025

(54) AUTOMATION RULE CREATION FOR COLLABORATION PLATFORMS

(71) Applicant: Atlassian Pty Ltd., Sydney (AU)

(72) Inventors: Anand Kashyap, San Jose, CA (US); Tyler Brown, Madison, WI (US); Trevor Angle, Austin, TX (US); Alexander Williams, Richmond, VA (US); Steven Zhang, Melbourne (AU); Eric Sukmajaya, Sydney (AU)

(21) Appl. No.: 18/399,319

(22) Filed: Dec. 28, 2023

(51) Int. Cl. G06F 9/54; G06F 3/0484; G06F 40/289; G06F 40/40

(52) U.S. Cl. CPC G06F 9/547; G06F 3/0484; G06F 40/289; G06F 40/40

(57) ABSTRACT

Embodiments described herein relate to systems and methods for automation rule creation for collaboration platforms. A natural language user input may be input to a centralized automation rule service that creates prompts for a generative output service to automatically create an automation rule understandable to one or more collaboration platforms of a system. A trigger-selection prompt, component-selection prompt, and rule-selection prompt are generated by the system and provided to the generative output engine. An automation rule can then be identified from the generative response, verified, and used in the system for the one or more collaboration platforms. In some cases, the automation rule creation from natural language input may reduce the burden on a user to craft and manage automation rules in a collaboration platform.

### TECHNICAL FIELD

Embodiments described herein relate to multitenant services of collaborative work environments and, in particular, to systems and methods for automation rule creation for collaboration platforms.

### BACKGROUND

An organization can establish a collaborative work environment by self-hosting, or providing its employees with access to, a suite of discrete software platforms or services to facilitate cooperation and completion of work. In many cases, the organization may also define policies outlining best practices for interacting with, and organizing data within, each software platform of the suite of software platforms.

Often internal best practice policies require employees to thoroughly document completion of tasks, assignment of work, decision points, and so on. Such policies additionally often require employees to structure and format documentation in particulars ways, to copy data or status information between multiple platforms at specific times, or to perform other rigidly defined, policy-driven, tasks. These requirements are both time and resource consuming for employees, reducing overall team and individual productivity.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system, such as described herein that can include and/or may receive input from a generative output engine.

FIG. 2A depicts an example frontend interface that supports automation rule creation for collaboration platforms, in accordance with aspects described herein.

FIG. 2B depicts an example frontend interface that supports automation rule creation for collaboration platforms, in accordance with aspects described herein.

FIG. 2C depicts an example process flow that supports automation rule creation for collaboration platforms, in accordance with aspects described herein.

FIG. 2D depicts an example process flow that supports automation rule creation for collaboration platforms, in accordance with aspects described herein.

FIG. 2E depicts an example process flow that supports automation rule creation for collaboration platforms, in accordance with aspects described herein.

FIG. 2F depicts an example process flow that supports automation rule creation for collaboration platforms, in accordance with aspects described herein.

FIG. 3 depicts an example process flow that supports automation rule creation for collaboration platforms, in accordance with aspects described herein.

FIG. 4 depicts an example frontend interface that supports automation rule creation for collaboration platforms, in accordance with aspects described herein.

FIG. 5 depicts an example frontend interface that supports automation rule creation for collaboration platforms, in accordance with aspects described herein.

FIG. 6A depicts a simplified diagram of a system, such as described herein that can include and/or may receive input from a generative output engine.

FIG. 6B depicts a functional system diagram of a system that can be used to implement a multiplatform prompt management service.

FIG. 7A depicts a simplified system diagram and data processing pipeline.

FIG. 7B depicts a system providing multiplatform prompt management as a service.

FIG. 8 shows a sample electrical block diagram of an electronic device that may perform the operations described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems, devices, and methods for automatically generating rules for collaboration platforms, such as documentation systems, issue tracking systems, project management platforms, and the like.

Collaboration platforms can be used to generate, store, and organize user-generated content. As described herein, a collaboration platform or service may include an editor that is configured to receive user input and generate user-generated content that is saved as a content item. The terms “collaboration platform” or “collaboration service” may be used to refer to a documentation platform or service configured to manage electronic documents or pages created by the system users, an issue tracking platform or service that is configured to manage or track issues or tickets in accordance with an issue or ticket workflow, a source-code management platform or service that is configured to manage source code and other aspects of a software product, a manufacturing resource planning platform or service configured to manage inventory, purchases, sales activity or other aspects of a company or enterprise. The examples provided herein are described with respect to an editor that is integrated with the collaboration platform. In some instances, the functionality described herein may be adapted to multiple platforms or adapted for cross-platform use through the use of a common or unitary editor service. For example, the functionality described in each example is provided with respect to a particular collaboration platform, but the same or similar functionality can be extended to other platforms by using the same editor service. Also, as described above a set of host services or platforms may be accessed through a common gateway or using a common authentication scheme, which may allow a user to transition between platforms and access platform-specific content without having to enter user credentials for each platform.

An automation rule (which may also be referred to as “automated rules,” or simply “rules”) is an automated workflow that is generally constructed in a “if this, then that” format. Typically, for example a collaboration platform, an automation rule results in the performance of an action upon the occurrence of a trigger, if certain conditions are met. In a collaboration platform, each rule automation rule is made by combining different types of components, including triggers and actions. An automation rule typically also includes a condition. Branches may also be used in some cases. As used herein, automation rules begin with a trigger (which may also be referred to as a trigger component), the trigger being the catalyst that sets the execution of a rule in motion. In one or more embodiments, a condition (which may also be referred to as a condition component) may also be used, where the condition is a limit on the scope of the automation rule. For example, a condition may require that the rule may only be run when the action that initiated the trigger was performed by a certain user or group of users. As used herein, an action (or action component) is what the rule to does or performs, for example what happens when the trigger (and conditions if applicable) are met. In some embodiments, an automation rule may also include a branch. A branch expands the performance or execution of a rule by adding a secondary path (a branch). As used herein, a branch is a sequence of conditions and/or actions that run in isolation from the rest of the rule, but are applied to each (e.g., every) instance of an object. For example, the rule for each task (e.g., an object) can be branched so that a message is sent to a recipient every time a person is mentioned on a particular page (e.g., when such page is published). This branch action occurs in addition to any action on the primary path of the automation rule chain.

In some cases, a collaboration platform may include a large amount of content to be managed. Certain tasks may require many repetitive actions or a person responsible for managing content may not realize that an action need to be performed to manage the content. As such, a collaboration platform may benefit from allowing users to establish automation rules to automatically perform such tasks that would otherwise need to be performed manually. Such automation rules can reduce management overhead, saving time and freeing up resources, and add management consistency, increasing transparency and organization, while reducing errors. However, the creation of automation rules can require multiple steps, technical acumen, knowledge of terms, connectors, and other specialized language that may not be known to a typical user of the collaboration platform. As such, improved techniques, devices, and processes are desired to facilitate the creation of automation rules for collaboration platforms, including the creation of automation rule using natural language inputs.

As further described herein, automation rule creation for collaboration platforms utilizing a generative output engine are described. In one or more embodiments, a user of a collaboration platform (e.g., a user of one or more systems, programs, applications, or components of a collaboration platform) enters a natural language string at an input field of a graphical user interface (GUI) of the content collaboration system. In response, the collaboration platform (e.g., a centralized automation rule service of the collaboration platform) generates one or more prompts for the generative output engine that are tailored to the content collaboration system. In some embodiments, the prompts include a trigger-selection prompt and a component-selection prompt used to solicit a trigger and one or more automation components or rule clauses as a generative response or responses from the generative output engine. The collaboration platform (e.g., a centralized automation rule service of the collaboration platform) can then generate another prompt for the generative output engine using the generative response or responses to solicit another generative response that includes one or more triggers for an automation rule, one or more automation components or rule clauses for the automation rule, and an object identifier for the automation rule. Using this returned response, the collaboration platform can then generate a service that performs an operation on one or more objects corresponding to the object identifier in response to an event satisfying the trigger(s), the operation corresponding to the one or more automation components or rule clauses.

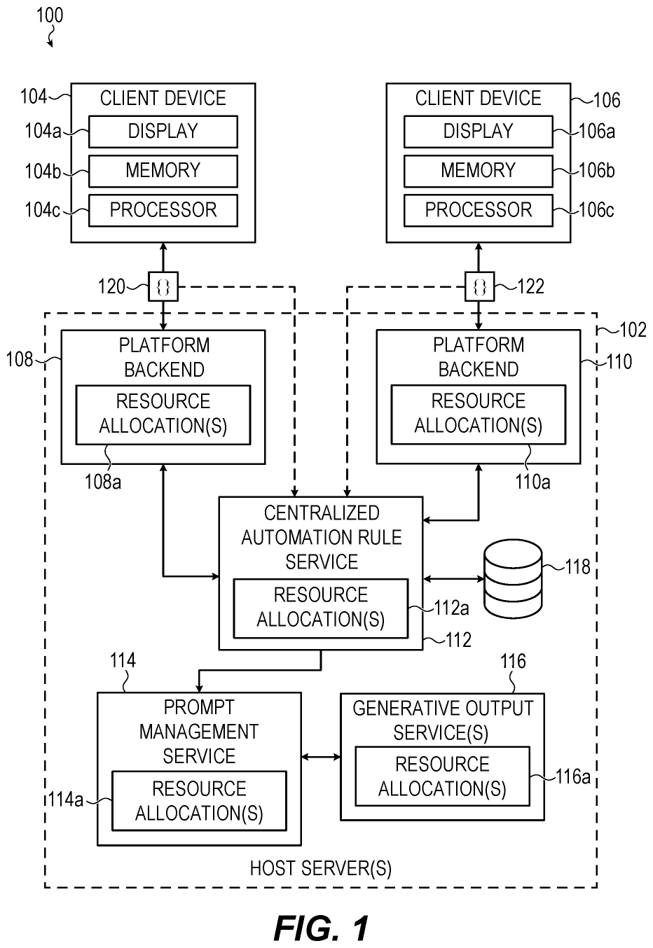

FIG. 1 depicts a simplified diagram of a system, such as described herein that can include and/or may receive input from a generative output engine as described herein. The system 100 is depicted as implemented in a client-server architecture, but it may be appreciated that this is merely one example and that other communications architectures are possible.

In particular the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices; two example devices are shown as the client device 104 and the client device 106. The client devices 104, 106 can be implemented as any suitable electronic device. In many embodiments, the client devices 104, 106 are personal computing devices such as desktop computers, laptop computers, or mobile phones.

The set of host servers 102 can be supporting infrastructure for one or more backend applications, each of which may be associated with a particular software platform, such as a documentation platform or an issue tracking platform. Other examples information technology system management (ITSM) systems, chat platforms, messaging platforms, and the like. These backends can be communicably coupled to a generative output engine that can be leveraged to provide unique intelligent functionality to each respective backend. For example, the generative output engine can be configured to receive user prompts, such as described above, to modify, create, or otherwise perform operations against content stored by each respective software platform.

By centralizing access to the generative output engine in this manner, the generative output platform can also serve as an integration between multiple platforms. For example, one platform may be a documentation platform and the other platform may be an issue tracking system. In these examples, a user of the documentation platform may input a prompt requesting a summary of the status of a particular project documented in a particular page of the documentation platform. A comprehensive continuation/response to this summary request may pull data or information from the issue tracking system as well.

A user of the client devices may trigger production of generative output in a number of suitable ways. One example is shown in FIG. 1. In particular, in this embodiment, each of the software platforms can share a common feature, such as a common centralized editor rendered in a frame of the frontend user interfaces of both platforms.

Turning to FIG. 1, a portion of the set of host servers 102 can be allocated as physical infrastructure supporting a first platform backend 108 and a different portion of the set of host servers 102 can be allocated as physical infrastructure supporting a second platform backend 110.

The two different platforms maybe instantiated over physical resources provided by the set of host servers 102. Once instantiated, the first platform backend 108 and the second platform backend 110 can each communicably couple to a centralized automation rule service 112 (also referred to more simply as an “editor” or an “editor service”).

The centralized automation rule service 112 can be configured to cause rendering of a frame within respective frontends of each of the first platform backend 108 and the second platform backend 110. In this manner, and as a result of this construction, each of the first platform and the second platform present a consistent user content editing experience.

More specifically, the centralized automation rule service 112 may be a rich text editor with added functionality (e.g., slash command interpretation, in-line images and media, and so on). As a result of this centralized architecture, multiple platforms in a multiplatform environment can leverage the features of the same rich text editor. This provides a consistent experience to users while dramatically simplifying processes of adding features to the editor.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized automation rule service 112 that can be called by each respective frontend whenever it is required to present the user of that respective frontend with an interface to edit text.

For example, the documentation platform's frontend may call upon the centralized automation rule service 112 to render, or assist with rendering, a user input interface element to receive user text input when a user of the documentation platform requests to being editing a document stored by the documentation platform backend.

Similarly, the issue tracking platform's frontend may call upon the centralized automation rule service 112 to render, or assist with rendering, a user input interface element to receive user text input when a user of the documentation platform opens a new issue (also referred to as a ticket), and begins typing an issue description.

In these examples, the centralized automation rule service 112 can parse text input provided by users of the documentation platform frontend and/or the issue tracking platform backend, monitoring for command and control keywords, phrases, trigger characters, and so on. In many cases, for example, the centralized automation rule service 112 can implement a slash command service that can be used by a user of either platform frontend to issue commands to the backend of the other system.

For example, the user of the documentation platform frontend can input a slash command to the content editing frame, rendered in the documentation platform frontend supported by the centralized automation rule service 112, in order to type a prompt including an instruction to create a new issue or a set of new issues in the issue tracking platform. Similarly, the user of the issue tracking platform can leverage slash command syntax, enabled by the centralized automation rule service 112, to create a prompt that includes an instruction to edit, create, or delete a document stored by the documentation platform.

As described herein, a “content editing frame” references a user interface element that can be leveraged by a user to draft and/or modify rich content including, but not limited to: formatted text; image editing; data tabling and charting; file viewing; and so on. These examples are not exhaustive; the content editing elements can include and/or may be implemented to include many features, which may vary from embodiment to embodiment. For simplicity of description the embodiments that follow reference a centralized automation rule service 112 configured for rich text editing, but it may be appreciated that this is merely one example.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized automation rule service 112 can be extended to include additional features and functionality—such as a slash command and control feature—which, in turn, can automatically be leveraged by any further platform that incorporates a content editing frame, and/or otherwise integrates with the centralized automation rule service 112 itself. In this example, slash commands facilitated by the editor service can be used to receive prompt instructions from users of either frontend. These prompts can be provided as input to a prompt engineering/prompt preconditioning service (such as the prompt management service 114) that, in turn, provides a modified user prompt as input to a generative output service 116.

The generative output engine service may be hosted over the host servers 102 or, in other cases, may be a software instance instantiated over separate hardware. In some cases, the generative engine service may be a third party service that serves an API interface to which one or more of the host services and/or preconditioning service can communicably couple.

The generative output engine can be configured as described above to provide any suitable output, in any suitable form or format. Examples include content to be added to user-generated content, API request bodies, replacing user-generated content, and so on.

In addition, a centralized automation rule service 112 can be configured to provide suggested prompts to a user as the user types. For example, as a user begins typing a slash command in a frontend of some platform that has integrated with a centralized automation rule service 112 as described herein, the centralized automation rule service 112 can monitor the user's typing to provide one or more suggestions of prompts, commands, or controls (herein, simply “preconfigured prompts”) that may be useful to the particular user providing the text input. The suggested preconfigured prompts may be retrieved from a database 118. In some cases, each of the preconfigured prompts can include fields that can be replaced with user-specific content, whether generated in respect of the user's input or generated in respect of the user's identity and session.

In some embodiments, the centralized automation rule service 112 can be configured to suggest one or more prompts that can be provided as input to a generative output engine as described herein to perform a useful task, such as generating automation rules from natural language inputs, managing and revising automation rules, and so on.

The ordering of the suggestion list and/or the content of the suggestion list may vary from user to user, user role to user role, and embodiment to embodiment. For example, when interacting with a documentation system, a user having a role of “developer” may be presented with prompts associated with tasks related to an issue tracking system and/or a code repository system.

Alternatively, when interacting with the same documentation system, a user having a role of “human resources professional” may be presented with prompts associated with manipulating or summarizing information presented in a directory system or a benefits system, instead of the issue tracking system or the code repository system.

More generally, in some embodiments described herein, a centralized automation rule service 112 can be configured to suggest to a user one or more prompts that can cause a generative output engine to provide useful output and/or perform a useful task for the user. These suggestions/prompts can be based on the user's role, a user interaction history by the same user, user interaction history of the user's colleagues, or any other suitable filtering/selection criteria.

In addition to the foregoing, a centralized automation rule service 112 as described herein can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More generally and broadly, the embodiments described herein refence systems and methods for sharing user interface elements rendered by a centralized automation rule service 112 and features thereof (such as a slash command processor), between different software platforms in an authenticated and secure manner. For simplicity of description, the embodiments that follow reference a configuration in which a centralized automation rule service is configured to implement a slash command feature—including slash command suggestions—but it may be appreciated that this is merely one example and other configurations and constructions are possible.

More specifically, the first platform backend 108 can be configured to communicably couple to a first platform frontend instantiated by cooperation of a memory and a processor of the client device 104. Once instantiated, the first platform frontend can be configured to leverage a display of the client device 104 to render a graphical user interface so as to present information to a user of the client device 104 and so as to collect information from a user of the client device 104. Collectively, the processor, memory, and display of the client device 104 are identified in FIG. 1 as the client devices resources 104a-104c, respectively.

As with many embodiments described herein, the first platform frontend can be configured to communicate with the first platform backend 108 and/or the centralized automation rule service 112. Information can be transacted by and between the frontend, the first platform backend 108 and the centralized automation rule service 112 in any suitable manner or form or format. In many embodiments, as noted above, the client device 104 and in particular the first platform frontend can be configured to send an authentication token 120 along with each request transmitted to any of the first platform backend 108 or the centralized automation rule service 112 or the preconditioning service or the generative output engine.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a graphical user interface so as to present information to a user of the client device 106 and so as to collect information from a user of the client device 106. Collectively, the processor, memory, and display of the client device 106 are identified in FIG. 1 as the client devices resources 106a-106c, respectively.

As with many embodiments described herein, the second platform frontend can be configured to communicate with the second platform backend 110 and/or the centralized automation rule service 112. Information can be transacted by and between the frontend, the second platform backend 110 and the centralized automation rule service 112 in any suitable manner or form or format. In many embodiments, as noted above, the client device 106 and in particular the second platform frontend can be configured to send an authentication token 122 along with each request transmitted to any of the second platform backend 110 or the centralized automation rule service 112.

As a result of these constructions, the centralized automation rule service 112 can provide uniform feature sets to users of either the client device 104 or the client device 106. For example, the centralized automation rule service 112 can implement a slash command processor to receive prompt input and/or preconfigured prompt selection provided by a user of the client device 104 to the first platform and/or to receive input provided by a different user of the client device 106 to the second platform.

As noted above, the centralized automation rule service 112 ensures that common features, such as slash command handling, are available to frontends of different platforms. One such class of features provided by the centralized automation rule service 112 invokes output of a generative output engine of a service such as the generative output service 116.

For example, as noted above, the generative output service 116 can be used to generate content, supplement content, and/or generate API requests or API request bodies that cause one or both of the first platform backend 108 or the second platform backend 110 to perform a task. In some cases, an API request generated at least in part by the generative output service 116 can be directed to another system not depicted in FIG. 1. For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

As with other embodiments described herein, the prompt management service 114 can be configured to receive user input (provided via a graphical user interface of the client device 104 or the client device 106) from the centralized automation rule service 112. The user input may include a prompt to be continued by the generative output service 116.

The prompt management service 114 can be configured to modify the user input, to supplement the user input, select a prompt from a database (e.g., the database 118) based on the user input, insert the user input into a template prompt, replace words within the user input, preform searches of databases (such as user graphs, team graphs, and so on) of either the first platform backend 108 or the second platform backend 110, change grammar or spelling of the user input, change a language of the user input, and so on. The prompt management service 114 may also be referred to herein as herein as an “editor assistant service” or a “prompt constructor.” In some cases, the prompt management service 114 is also referred to as a “content creation and modification service.”

Output of the prompt management service 114 can be referred to as a modified prompt or a preconditioned prompt. This modified prompt can be provided to the generative output service 116 as an input. More particularly, the prompt management service 114 is configured to structure an API request to the generative output service 116. The API request can include the modified prompt as an attribute of a structured data object that serves as a body of the API request. Other attributes of the body of the API request can include, but are not limited to: an identifier of a particular LLM or generative engine to receive and continue the modified prompt; a user authentication token; a tenant authentication token; an API authorization token; a priority level at which the generative output service 116 should process the request; an output format or encryption identifier; and so on. One example of such an API request is a POST request to a Restful API endpoint served by the generative output service 116. In other cases, the prompt management service 114 may transmit data and/or communicate data to the generative output service 116 in another manner (e.g., referencing a text file at a shared file location, the text file including a prompt, referencing a prompt identifier, referencing a callback that can serve a prompt to the generative output service 116, initiating a stream comprising a prompt, referencing an index in a queue including multiple prompts, and so on; many configurations are possible).

In response to receiving a modified prompt as input, the generative output service 116 can execute an instance of a generative output engine, such as an LLM. As noted above, in some cases, the prompt management service 114 can be configured to specify what engine, engine version, language, language model or other data should be used to continue a particular modified prompt.

The selected LLM or other generative engine continues the input prompt and returns that continuation to the caller, which in many cases may be the prompt management service 114. In other cases, output of the generative output service 116 can be provided to the centralized automation rule service 112 to return to a suitable backend application, to in turn return to or perform a task for the benefit of a client device such as the client device 104 or the client device 106. More particularly, it may be appreciate that although FIG. 1 is illustrated with only the prompt management service 114 communicably coupled to the generative output service 116, this is merely one example and that in other cases the generative output service 116 can be communicably coupled to any of the client device 106, the client device 104, the first platform backend 108, the second platform backend 110, the centralized automation rule service 112, or the prompt management service 114.

In some cases, output of the generative output service 116 can be provided to an output processor or gateway configured to route the response to an appropriate destination. For example, in an embodiment, output of the generative engine may be intended to be prepended to an existing document of a documentation system. In this example, it may be appropriate for the output processor to direct the output of the generative output service 116 to the frontend (e.g., rendered on the client device 104, as one example) so that a user of the client device 104 can approve the content before it is prepended to the document. In another example, output of the generative output service 116 can be inserted into an API request directly to a backend associated with the documentation system. The API request can cause the backend of the documentation system to update an internal object representing the document to be updated. On an update of the document by the backend, a frontend may be updated so that a user of the client device can review and consume the updated content.

In other cases, the output processor/gateway can be configured to determine whether an output of the generative output service 116 is an API request that should be directed to a particular endpoint. Upon identifying an intended or specified endpoint, the output processor can transmit the output, as an API request to that endpoint. The gateway may receive a response to the API request which in some examples, may be directed to yet another system (e.g., a notification that an object has been modified successfully in one system may be transmitted to another system).

More generally, the embodiments described herein and with particular reference to FIG. 1 relate to systems for collecting user input, modifying that user input into a particularly engineered prompt, and submitting that prompt as input to a trained large language model. Output of the LLM can be used in a number of suitable ways

In some embodiments, user input can be provided by text input that can be provided by a user typing a word or phrase into an editable dialog box such as a rich text editing frame rendered within a user interface of a frontend application on a display of a client device. For example, the user can type a particular character or phrase in order to instruct the frontend to enter a command receptive mode. In some cases, the frontend may render an overlay user interface that provides a visual indication that the frontend is ready to receive a command from the user. As the user continues to type, one or more suggestions may be shown in a modal UI window.

These suggestions can include and/or may be associated with one or more “preconfigured prompts” that are engineered to cause an LLM to provide particular output. More specifically, a preconfigured prompt may be a static string of characters, symbols and words, that causes—deterministically or pseudo-deterministically—the LLM to provide consistent output. For example, a preconfigured prompt may be “generate a summary of changes made to all documents in the last two weeks.” Preconfigured prompts can be associated with an identifier or a title shown to the user, such as “Summarize Recent System Changes.” In this example, a button with the title “Summarize Recent System Changes” can be rendered for a user in a UI as described herein. Upon interaction with the button by the user, the prompt string “generate a summary of changes made to all documents in the last two weeks” can be retrieved from a database or other memory, and provided as input to the generative output service 116.

Suggestions rendered in a UI can also include and/or may be associated with one or more configurable or “templatized prompts” that are engineered with one or more fields that can be populated with data or information before being provided as input to an LLM. An example of a templatized prompt may be “summarize all tasks assigned to ${user} with a due date in the next 2 days.” In this example, the token/field/variable ${user} can be replaced with a user identifier corresponding to the user currently operating a client device.

This insertion of an unambiguous user identifier can be performed by the client device, the platform backend, the centralized automation rule service, the prompt management service, or any other suitable software instance. As with preconfigured prompts, templatized prompts can be associated with an identifier or a title shown to the user, such as “Show My Tasks Due Soon.” In this example, a button with the title “Show My Tasks Due Soon “can be rendered for a user in a UI as described herein. Upon interaction with the button by the user, the prompt string “summarize all tasks assigned to userl23 with a due date in the next 2 days” can be retrieved from a database or other memory, and provided as input to the generative output service 116.

Suggestions rendered in UI can also include and/or may be associated with one or more “engineered template prompts” that are configured to add context to a given user input. The context may be an instruction describing how particular output of the LLM/engine should be formatted, how a particular data item can be retrieved by the engine, or the like. As one example, an engineered template prompt may be “${user prompt}. Provide output of any table in the form of a tab delimited table formatted according to the markdown specification.” In this example, the variable ${user prompt} may be replaced with the user prompt such that the entire prompt received by the generative output service 116 can include the user prompt and the example sentence describing how a table should be formatted.

In yet other embodiments, a suggestion may be generated by the generative output service 116. For example, in some embodiments, a system as described herein can be configured to assist a user in overcoming a cold start/blank page problem when interacting with a new document, new issue, or new board for the first time. For example, an example backend system may be Kanban board system for organizing work associated with particular milestones of a particular project. In these examples, a user needing to create a new board from scratch (e.g., for a new project) may be unsure how to begin, causing delay, confusion, and frustration.

In these examples, a system as described herein can be configured to automatically suggest one or more prompts configured to obtain output from an LLM that programmatically creates a template board with a set of template cards. Specifically, the prompt may be a preconfigured prompt as described above such as “generate a JSON document representation of a Kanban board with a set of cards each representing a different suggested task in a project for creating a new iced cream flavor.” In response to this prompt, the generative output service 116 may generate a set of JSON objects that, when received by the Kanban platform, are rendered as a set of cards in a Kanban board, each card including a different title and description corresponding to different tasks that may be associated with steps for creating a new ice cream flavor. In this manner, the user can quickly be presented with an example set of initial tasks for a new project.

In yet other examples, suggestions can be configured to select or modify prompts that cause the generative output service 116 to interact with multiple systems. For example, a suggestion in a documentation system may be to create a new document content section that summarizes a history of agent interactions in an ITSM system. In some cases, the generative output service 116 can be called more than once (and/or it may be configured to generate its own follow-up prompts or prompt templates which can be populated with appropriate information and re-submitted to the generative output service 116 to obtain further generative output. More simply, in some embodiments, generative output may be recursive, iterative, or otherwise multi-step in some embodiments.

These foregoing embodiments depicted in FIG. 1 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a.

Similarly, the second platform backend 110 may be instantiated over the resource allocations 110a (including processors, memory, storage, network communications systems, and so on). Likewise, the centralized automation rule service 112 is supported by a processor and memory and network connection (and/or database connections) collectively represented for simplicity as the resource allocations 112a.

The prompt management service 114 can be supported by its own resources including processors, memory, network connections, displays (optionally), and the like represented in the figure as the resource allocations 114a.

In many cases, the generative output service 116 may be an external system, instantiated over external and/or third-party hardware which may include processors, network connections, memory, databases, and the like. In some embodiments, the generative output service 116 may be instantiated over physical hardware associated with the host servers 102. Regardless of the physical location at which (and/or the physical hardware over which) the generative output service 116 is instantiated, the underlying physical hardware including processors, memory, storage, network connections, and the like are represented in the figure as the resource allocations 116a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Generally, generative output systems, as described herein, should not be usable to obtain information from an organizations datasets that a user is otherwise not permitted to obtain. For example, a prompt of “generate a table of social security numbers of all employees” should not be executable. In many cases, underlying training data may be siloed based on user roles or authentication profiles. In other cases, underlying training data can be preconditioned/scrubbed/tagged for particularly sensitive datatypes, such as personally identifying information. As a result of tagging, prompts may be engineered to prevent any tagged data from being returned in response to any request. More particularly, in some configurations, all prompts output from the prompt management service 114 may include a phrase directing an LLM to never return particular data, or to only return data from particular sources, and the like.

In some embodiments, the system 100 can include a prompt context analysis instance configured to determine whether a user issuing a request has permission to access the resources required to service that request. For example, a prompt from a user may be “Generate a text summary in Document123 of all changes to Kanban board 456 that do not have a corresponding issue tagged in the issue tracking system.” In respect of this example, the prompt context analysis instance may determine whether the requesting user has permission to access Documentl23, whether the requesting user has written permission to modify Documentl23, whether the requesting user has read access to Kanban board 456, and whether the requesting user has read access to referenced issue tracking system. In some embodiments, the request may be modified to accommodate a user's limited permissions. In other cases, the request may be rejected outright before providing any input to the generative output service 116.

Furthermore, the system can include a prompt context analysis instance or other service that monitors user input and/or generative output for compliance with a set of policies or content guidelines associated with the tenant or organization. For instance, the service may monitor the content of a user input and block potential ethical violations including hate speech, derogatory language, or other content that may violate a set of policies or content guidelines. The service may also monitor output of the generative engine to ensure the generative content or response is also in compliance with policies or guidelines. To perform these monitoring activities, the system may perform natural language processing on the monitored content in order to detect key words or phrases that indicate potential content violations. A trained model may also be used that has been trained using content known to be in violation of the content guidelines or policies.

Further to these foregoing embodiments, it may be appreciated that a user can provide input to a frontend of a system in a number of suitable ways, including by providing input as described above to a frame rendered with support of a centralized automation rule service.

As further described herein, the system 100 supports automation rule creation. In one or more embodiments, a graphical user interface (GUI) is displayed at a client device that includes an input field. In some cases, the client device 104, associated with the first platform backend 108, provides an interface with a first type of software platform, and the client device 106, associated with the second platform backend 110, provides an interface with a different type of software platform. Either or both of client device 104 or client device 106 may generate a GUI allowing user input for automation rule generation. The user input can be formatted as natural language input to the system. As further described herein, the host servers 102 can utilize the services of a generative output service 116 to programmatically generate automation rules from natural language inputs.

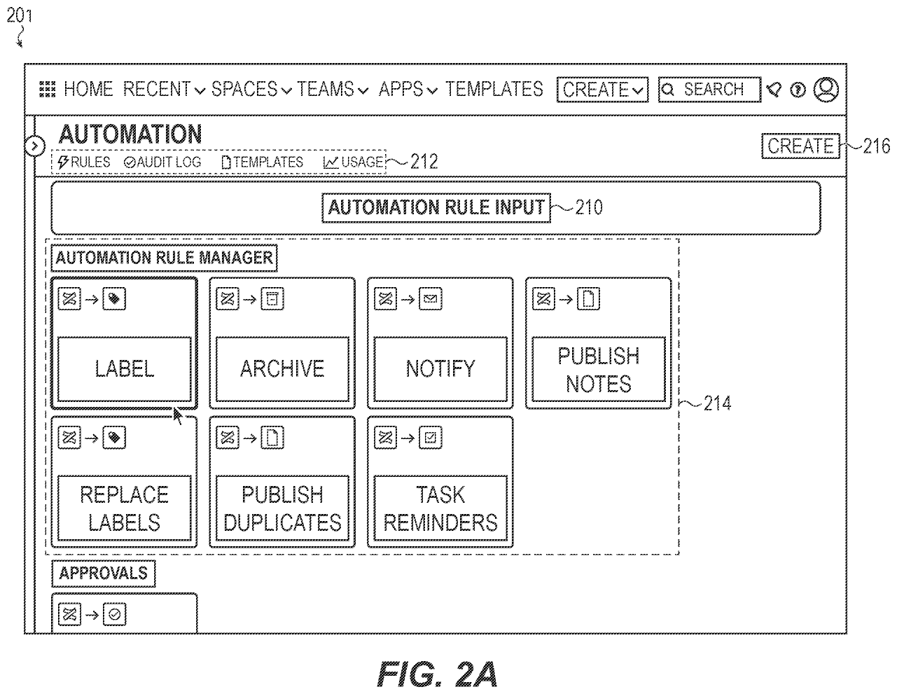

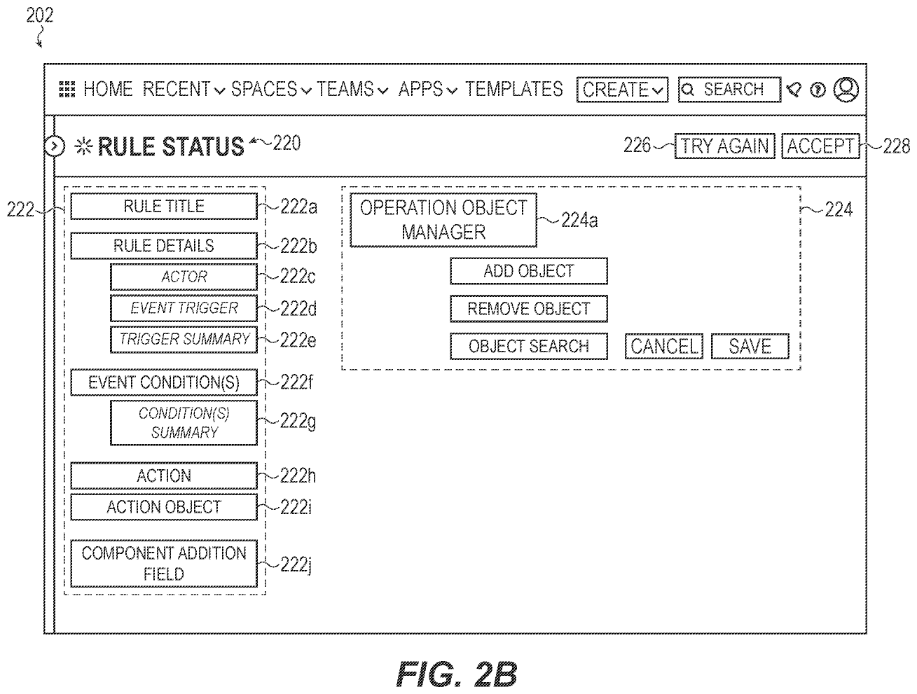

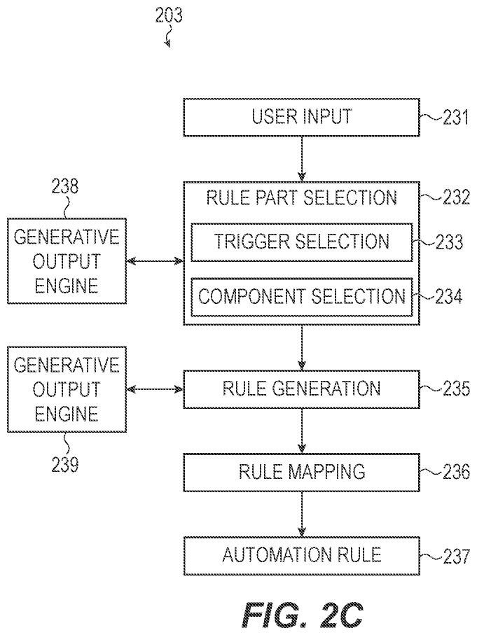

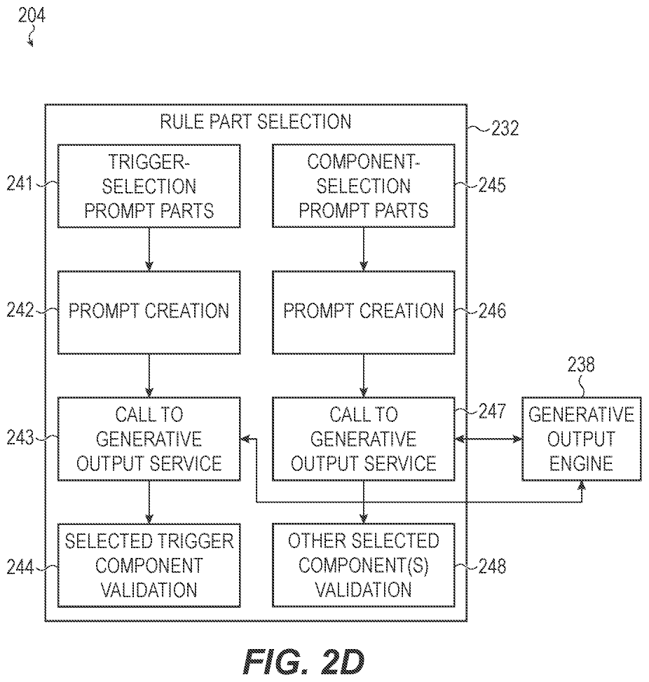

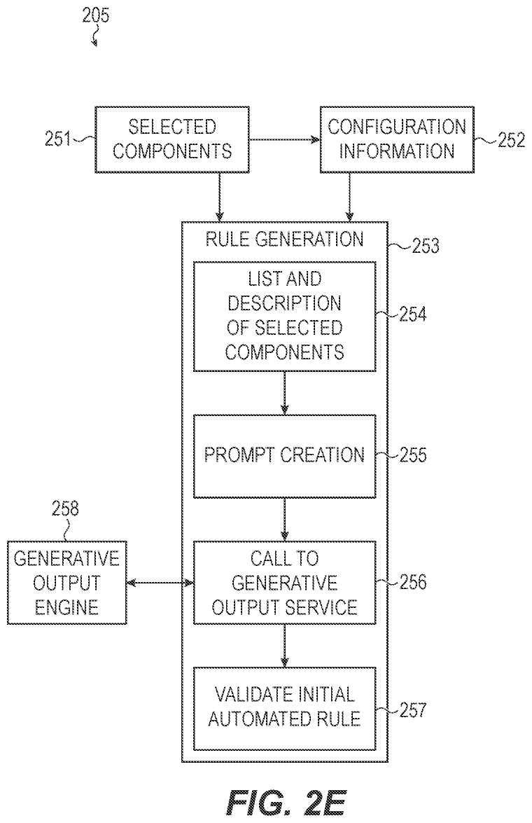

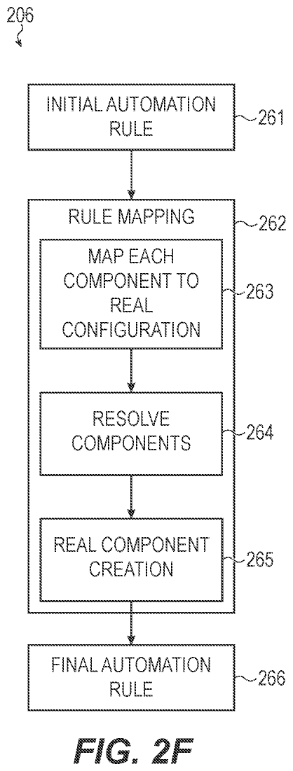

FIG. 2A depicts an example frontend interface 201 that supports automation rule creation for collaboration platforms, in accordance with aspects described herein. Frontend interface 201 may also be referred to as a UI or GUI. The frontend interface 201 can be rendered by a client device 104 or a client device 106, which may be a personal electronic device such as a laptop, desktop computer, tablet and the like. The client device can include a display with an active display area in which a user interface, e.g., frontend interface 201 can be rendered. The user interface can be rendered by operation of an instance of a frontend application associated with a backend application that collectively define a software platform as described herein.

More particularly, as described with reference to FIG. 1, a platform can be defined by communicably intercoupling one or more frontend instances with one or more backend instances. The backend instance of software can be instantiated over server hardware such as a processor, memory, storage, and network communications. The frontend application can be instantiated over physical hardware of a client device in network communication with the backend application instance. The frontend application can be a native application, a browser application, or other application type instantiated over hardware directly or indirectly, such as within an operating system environment.

As shown, frontend interface 201 includes a text input field 210, selectable tabs 212, a display area 214, and a create button 216. Text input field 210 is field configured to accept textual inputs, and in particular a natural language rule for the creation of automation rules. The create button 216 can be used to submit the natural language rule input in the text input field 210 for creation of an automation rule by the system 100 using a generative output service, as further described herein.

In one or more embodiments, selectable tabs 212 include tabs for “rules,” “an audit log,” “templates,” and “usage,” each of which may cause a different display to appear in display area 214. Selecting the rules field causes the display area 214 to display automation rules for management. The information for the displayed rule can include at least a name, description scope (e.g., on what projects, or types of projects, the rule will run), an indication of whether to allow the rule to run from another rule, an error notification status, an owner of the rule, a rule actor (e.g., the party indicated as responsible when the rule is executed), and permissions for the rule (e.g., persons or groups allowed to modify the rule). As an example of automation rules, an automation rule manager may display a list, icon, or other indicator of automation rules created by a user in display area 214. Examples of such automation rules (e.g., created or for a template, as further discussed herein) include a “label” rule (e.g., adding a specific label when a page is published by a certain author), an “archive” rule (e.g., archiving inactive pages when scheduled (recurring)), a “notify” rule (e.g., notify certain people about inactive pages when scheduled (recurring)), a “publish notes” rule (e.g., publish new meeting notes page when scheduled (recurring)), a “replace labels” rule (e.g., replace a label on all pages when scheduled (recurring)), a “publish duplicates” rule (e.g., publish the same set of pages when a new space is created), and a “task reminders” rule (e.g., remind teammates about incomplete tasks when scheduled (recurring)). In some embodiments, these example rules may support automation rules within a documentation platform. In other embodiments such rules, or other rules, can be for other platforms or a combination of platforms within a system including collaboration platforms.

In one or more embodiments, selecting the templates tab may cause a display to appear in display area 214 that includes templates that a user may utilize to create automation rules from a template. Such templates provide predefined structure for common automation rules that a user may want to use in the manual creation of an automation rule.

In one or more embodiments, selecting the audit log tab may cause a display to appear in display area 214 that includes an audit log for the automation rules. In one or more embodiments, each automation rule may include an audit log that identifies when the automation rule was triggered, the final result of the execution of the automation rule, and any action performed as a result of the automation rule execution. In some embodiments, the audit log may indicate a duration of the execution and the status (e.g., success, error, and so on) of the execution.

In one or more embodiments, selecting the usage tab may cause a display to appear in display area 214 that includes usage information for the automation rules. The usage information includes an outline of your automation usage (e.g., for a particular time frame). For example, each automation rule may be identified, together with a quantity of runs/executions of the automation rule, an “owner” or other responsible person for the rule, a scope of the rule (e.g., which collaboration systems are associated with the rule), and an activation status for the automation rule (e.g., whether execution of the rule is turned “on” or “off”).

According to one or more embodiments, previously-created automation rule, including automation rules generate from v using a generative output engine, as further described herein, can be stored at the system 100. In some examples, rules may be stored in a database 118 for retrieval and use by a component of the set of host servers 102, such as the centralized automation rule service 112, the first platform backend 108, or the second platform backend 110. In some examples, the rules may be stored in the resource allocation of a portion of the host servers 102, such as the resource allocation of the platform from which the automation rule is to be executed, for example resource allocations 108a of the first platform backend 108, or resource allocations 110a of the second platform backend 110.

FIG. 2B depicts an example frontend interface 202 that supports automation rule creation for collaboration platforms, in accordance with aspects described herein. Frontend interface 202 may also be referred to as a UI or GUI. In one or more embodiments, frontend interface 202 may be displayed at a same display or interface as frontend interface 201, for example rendered in response to a user providing a natural language input to the text input field 210, and requesting (e.g., initiating) the creation of an automation rule using the create button 216. The frontend interface 202 displays an output automation rule 222 responsive to the automation rule creation process.

Portions making up an automation rule are represented and shown in an area for an output automation rule 222 on the frontend interface 202. The rule title 222a includes a natural language description of the rule, which can be the same or different than the natural language input provided as input to the text input field 210. Rule details 222b can provide information related to the automation rule, such as an actor 222c for the rule. Changes performed by the automation rule are seen as being performed by the actor 222c. In one or more embodiments, the actor 222c is the person who created the rule. In some embodiments, the actor 222c is the user, for example the user that submitted the natural language rule input in the text input field 210 for creation of the automation rule by the system 100.

Event trigger 222d indicates the trigger of the automation rule, and may be described in summary fashion by trigger summary 222e. In one example, the event trigger may be “When: Page published,” and the trigger summary may provide that the “Rule is run when a new page is published.” In one or more embodiments, the automation rule always begins with a trigger component, the trigger being the catalysts that sets the execution of the automation rule in motion.

In one or more embodiments, triggers for event trigger 222d include one or more of a page archived, page commented, page copied, page deleted, page edited, page labeled, page moved, page owner changed, page published, page status changed, attachment added to page, attachment deleted from page, attachment deleted from page, manual trigger from page, task created, task status changed, blog commented, blog labeled, blog published, attachment added to blog, attachment deleted from blog, user mentioned, space archived, space created, or a combination of these. In some embodiments, the trigger may be a scheduled time. In one or more embodiments, these triggers are for a documentation platform.

In one or more embodiments, triggers for event trigger 222d include one or more of a field value changed, form submitted, incoming webhook, issue assigned, issue commented, issue comment edited, issue created, issue deleted, issue linked, issue link deleted, issue moved, issue transitioned, issue updated, a manual trigger from an issue, a combination of issues, when work is logged, a sprint is created, started, or completed, a version is created, updated, or released, a branch created, build failed, build status changed, build successful, commit created, deployment failed, deployment status changed, deployment successful, pull request create, pull request, declined, pull request merged, vulnerability found, object triggered, service limit breach, a service legal agreement threshold breached, approval required, approval completed, or an emoji reaction to application message. In one or more embodiments, these triggers are for an issue tracking platform.

Event condition(s) 222f indicates the condition of the automation rule, and may be described in summary fashion by event condition(s) 222g. In one or more embodiments, the automation rule always begins with a trigger component, the trigger being the catalysts that sets the execution of the automation rule in motion, and includes an event condition (which may also be referred to as just a condition) that must be met in order for the automation rule to continue to run. In some examples, there is a single one of event conditions 222f. In other embodiments, multiple of event conditions 222f are used, and may be set to occur at any point within the automation rule chain. In one or more embodiments, event condition(s) 222f are optional, and need not be present in every automation rule for the automation rule to be valid. In some embodiments, event condition(s) 222f are in if-then or if-then-else form.

In one or more embodiments, examples of event condition(s) 222f include a user, a database query (e.g., a Confluence querying language (CQL)), such as a query in the form of an “if” statement for a contents of a page, blog, comment, or attachment, a compare, an if-else statement, or a combination of these. In some embodiments, these conditions are for a documentation platform.

In one or more embodiments, examples of event condition(s) 222f include compare functions, which may be values or regular expressions. In one or more embodiments, values for a compare function may include one or more of an issue, conditional logic, users, test fields, date and time, JavaScript Object Notation (JSON) function, math expression, list, or a combination of these. In some embodiments, these conditions are for an issue tracking platform.

Action(s) 222g indicates the action to be performed following the event trigger and, if present, if the event condition of the automation rule are met. The action object 222i indicates the object on which the action is performed. Action 222h are what the rule is to do or, stated differently, what happens if the automation rule executes successfully.

In one or more embodiments, examples of action or action 222h include page archiving, page ownership changing, page status changing, page copying, page deletion, page moving, new page publishing, page restriction, blog deletion, comment addition, label addition, label removing, watcher management, space permission adding, space archiving, or a combination of these. In some embodiments, these actions are for a documentation platform.

In one or more embodiments, examples of action(s) 222g include emailing sending, application messaging sending, text message sending, web request sending, variable creation, action logging, or a combination of these. In some embodiments, these actions are for an issue tracking platform.

In some embodiments, component addition field 222j can be used to manually add components to the automation rule, such as further event conditions or actions.

In one or more embodiments, a component modification area 224 can be used to modify one or more components of an automation rule. As shown in FIG. 2B, operation object manager 224a is illustrated for modification of an action 222h and action object 222i. In other embodiments, the component modification area 224 can be or include a trigger manager, a condition manager, a branch manager (a branch is not illustrated for the automation rule in FIG. 2B), or a combination of these.

A rule status 220 may be used to indicate that the automation rule was created using a generative output engine, for example as opposed to created manually or from some other, alternative process. In the event that a user is not satisfied with the output of the automation rule generation process, realizes that an error in the input text occurred or for any other reason, the user may select the try again button 226. In the event that the user is satisfied with the generated automation rule, then the automation rule may be accepted via the accept button 228, which may also be an “ok” button, or the like.

FIG. 2C depicts an example process flow 203 that supports automation rule creation for collaboration platforms, in accordance with aspects described herein. Process flow 203 includes operations that may be performed by system 100, which may also be referred to as a content collaboration system herein.

At 231, a natural language user input is received at the system 100. In one or more embodiments, system 100 (e.g., including at least the centralized automation rule service 112) causes a GUI, including an input field for receiving user input, to be generated (e.g., at one or more of a client device 104 or client device 106). In some embodiments, the GUI is frontend interface 201, or a portion thereof. In some embodiments the GUI includes at least the text input field 210 for an automation rule input, an example of which is frontend interface 201.

At 232, rule parts are selected. In one or more embodiments, system 100 performs trigger selection 233 and component selection 234. In some embodiments, rule part selection is performed by a combination of components of system 100, including one or more of centralized automation rule service 112, prompt management service 114, or generative output service 116. In one or more embodiments, generative output service 116 may be, be referred to as, or include a generative output engine. In some embodiments, generative output engine 238 may be internal to system 100. In some embodiments, generative output engine 238 may be external to system 100. For example, generative output service 116 may coordinate or otherwise operate to facilitate communications and services with the generative output engine 238, which may be a service provided by a third party, for example.

In one or more embodiments, trigger selection 233 includes generating a trigger-selection prompt, providing the trigger-selection prompt to a generative output engine using a first API interface call, and obtaining a first generative response from the generative output engine response to the first API interface call. At 238, the generative output engine 238 may take as an input the trigger-selection prompt, and provide as an output the first generative response. In some embodiments, the trigger-selection prompt includes least a first portion of the natural language string, a set of example automation trigger schemas, and a set of example input-output natural language to trigger pairs. The trigger(s) for trigger selection 233 may be one or more of the triggers discussed herein, for example with reference to frontend interface 202.

In one or more embodiments, component selection 234 includes generating a component-selection prompt, providing the component-selection prompt to a generative output engine using a second API interface call, and obtaining a second generative response from the generative output engine response to the second API interface call. At 238, the generative output engine 238 may take as an input the component-selection prompt, and provide as an output the second generative response. In some embodiments, the component-selection prompt includes least a second portion of the natural language string, a set of example automation components or rule clauses, and a set of example input-output natural language to automation component or rule clause pairs. The component(s) for component selection 234 may be one or more of the components discussed herein, for example one or more event condition(s) and/or actions described with reference to frontend interface 202. In some embodiments, the automation component or rule clause pairs may include branches, and the set of examples of input-output natural language to automation component or rule clause pairs may include examples mapping natural language branching terms to branch terms used by one or more platforms of the system 100.

An example of at least a portion of a prompt provided as input, including exemplary triggers, conditions, actions, and an automation trigger schema may be:

```
{
″product″: ″Documentation Platform″,
″generative_output_service_config″: {
  ″user intent″: ″You are a helpful assistant.
  Use the following knowledge to create rules.
  ## Issue Fields
  An issue contains the following fields:
  - Status: one of ′todo′, ′in progress′, ′done′.
  - Priority: one of ′high′, medium′, ′low′.
  - Assignee: the Id of the assigned user.
  - Summary: the summary of the issue.
  - Description: the description of the issue.
  ## Automation Rule
  An automation rule contains ′name′, ′trigger′, and one or multiple
  ′components′.
  ### Triggers
  #### Issue Created
  Rule is run when an issue is created. This trigger needs no
  configuration.
  - Type: ′issue_created′
  #### Issue Updated
  Rule is run when an issue is updated. This trigger needs no
  configuration.
  - Type: ′issue updated′
  #### Issue Assigned
  Rule is run when an issue is assigned to a user. This trigger needs no
  configuration.
  - Type: ′issue_assigned′
  ### Conditions
  #### Issue Field Condition
  Checks whether an issue′s field meets certain criteria. It contains fields.
  - Type: ′issue_field_condition′
  - Field: the name of the issue field
  Condition: one of ′equals′, ′does not equal′, ′is one of′, ′is not
    one of′
  - Value: the value of the issue field
  ### Actions
  #### Assign Issue
  Assign an issue to a user
  - Type: ′issue_updated′
  #### Issue Assigned
  Rule is run when an issue is assigned to a user. This trigger needs no
  configuration.
  - Type: ′issue_assigned′
  #### Send Email
  Send an email to the given email address. It contains the following
  fields
  - Type: ′send_email′
  - To: the email address
  - Subject: the subject of the email
  - Content: the content of the email
  ## Rule Schema
  Below is the JSON schema to create rule data. The trigger can only be
  one of ′issue_created′, ′issue_updated′, ′issue_assigned′
  ″′json
  {
      ″$schema″: ″http://json-schema.org/.../schema#,
      ″type″: ″object″,
      ″required″: [″name″, ″trigger″, ″components″],
      ″properties″: {
        ″name″: {
          ″type″: ″string″,
          ″description″: ″the name of the automation rule″
        }
      ″trigger″: {
        ″$ref″: ″#/definitions/component″,
        ″description″: ″It can only be a rule trigger. It can not be an
        action.″
      }
      ″components″: {
        ″type″: ″array″,
        ″items″: {
          $ref″: ″#/definitions/component″
        },
        ″description″: ″the actions and conditions for the automation
        rule″
      }
  }
```

In some cases, the pseudo-query language translation of the input prompt may be, itself, a generative output of a generative output engine. In these examples, a first request may be submitted to a generative output engine. In response to receiving this modified prompt, the generative output engine may generate the previous example pseudo-query language query.

Rule generation 235 includes generating a rule-selection prompt for the generative output engine 239, providing the rule-selection prompt to the generative output engine using a third API call, and obtaining a third generative response from the generative output engine responsive to the third API call. In one or more embodiments, the rule-selection prompt includes at least a portion of the first generative response (associated with the trigger selection 233), at least a portion of the second generative response (associated with the component selection 234), and a set of example automation rules.

Generative output engine 239 may be the same as, or different from, generative output engine 238. For example, generative output engine 238 may be or use a same third party service as generative output engine 239. In other examples, generative output engine 238 may be or use a different third party service then generative output engine 239.

In one or more embodiments, the third generative response includes a textual output, which is mapped to components specific to a platform applicable for the automation rule. The textual output of the third generative response may be or be referred to as an initial automation rule. As such, rule mapping 236 includes identifying, based on the third generative response, one or more automation rule components, for example specific to the platform or platforms (e.g., for an automation rule that operates from one or more platforms to one or more different platforms).

In some embodiments, the automation rule components are triggers, one or more automation components or rule clauses, and an object identifier. For example, the trigger may be one or more of the event triggers described herein, such as an event trigger described with reference to the frontend interface 202 (e.g., event trigger 222d). The one or more automation components or rule clauses may be one or more of the event conditions, actions, or both, described herein, such as an event condition described with reference to the frontend interface 202 (e.g., event conditions 222f), or an action described with reference to the frontend interface 202 (e.g., action 222h). The object identifier may identify an object of a platform of system 100 (or more than one platform, such as an object applicable across multiple platforms), such as an action object described with reference to the frontend interface 202 (e.g., action object 222i).

Following rule mapping 236, an automation rule 237 may be constructed. In one or more embodiments, a representation of the automation rule 237 may be displayed at a GUI at a frontend interface (e.g., frontend interface 202), which may be a GUI at one or both of client device 104 or client device 106. For example, the automation rule 237 may be represented by an output automation rule 222. In one or more embodiments, finalizing or otherwise completing the automation rule 237 (e.g., by saving the automation rule from the GUI) may include generating a service on the content collaboration system (e.g., system 100) that performs an operation in response to an event satisfying the one or more triggers. The operation may correspond to the one or more automation components or rule clauses, and the operation may be performed on a set of objects selected using the object identifier. In some examples, the automation rule 237 may be a complete or final automation rule, usable by system 100.

FIG. 2D depicts an example process flow 204 that supports automation rule creation for collaboration platforms, in accordance with aspects described herein. Process flow 204 includes operations that may be performed by system 100, which may also be referred to as a content collaboration system herein. In one or more embodiments, process flow 204 illustrates portions of rule part selection 232, described herein.

In a particular example, trigger-selection prompt parts 241 are identified. The trigger-selection prompt parts 241 may include one or more trigger components of a set of available trigger components making up an automation trigger schemas. In some examples, the automation trigger schemas may provide the generative output engine with a base set of triggers for one or more platforms of the system 100 that the generative output engine may use as part of the trigger-selection. The trigger-selection prompt parts 241 may further include a set of example input-output natural language to trigger pairs. In some examples, such pairs may be used to provide the generative output engine with a set of “correct” or “reference” mappings that may be used by the generative output engine to learn how to correctly apply the natural language input to the triggers.

Prompt creation 242 includes the generation of the trigger-selection prompt. Generally, the prompt (e.g., a message formatted to send to the generative output engine, for example via an API call) includes information about what is automation (e.g., what is an automation rule) and that the purpose of the prompt is to create automation rules. The trigger-selection prompt also includes a list of each automation rule component, and a description of the components. The trigger-selection prompt also includes a list of example prompts, and a correct output for the associated prompt. A function for the prompt creation 242 may be created to select components needed for the prompt. The function may take a list of components (e.g., a comma separated list of components), for example “PagePublishedTrigger,” “CQLCondition,” “AddLabelAction,” or another trigger, condition, action, or other component described herein. In some embodiments, prompt creation is performed with the identity of the automation rule components and their associated function (e.g., what the component does), but is in the absence of a configuration for one or more, or all, of the automation rule components.

Following prompt creation, the trigger-selection prompt (e.g., as a request message) may be sent to the generative output engine 238 via an API call. In some example, the generative output engine 238 may be internal to the system 100, and a request message may be sent via an API call for such generative output engine 238 that is internal, or the request message may be according to another message format or structure. Generative output engine 238 may process the trigger-selection prompt as described herein, and return a generative response, indicating a trigger selected for the natural language input of the automation rule.

In one or more embodiments, the returned generative response related to the trigger-selection prompt is subject to validation. In particular, the selected trigger or triggers may be validated to determine whether each trigger makes sense in the context of the applicable platform. For example, the selected trigger may be checked against a list of exemplary or allowed triggers. In some cases, the generative output engine 238 may “hallucinate” or otherwise erroneously create or fabricate triggers where none exists, or in violation of a rule of usage within the platform, and validation is used to prevent erroneous results.

In addition to the trigger-selection prompt parts 241 that are identified, the component-selection prompt parts 245 are identified. The component-selection prompt parts 245 may include one or more components (e.g., other automation components than the trigger components), such as of a set of example automation components or rule clauses. In some examples, the set of example automation components or rule clauses (e.g., event condition(s), action(s), branches, and so on) provide the generative output engine with a base set of components for one or more platforms of the system 100 that the generative output engine may use as part of the component-selection. The component-selection prompt parts 245 may further include a set of example input-output natural language to is automation component or rule clause pairs. In some examples, such pairs may be used to provide the generative output engine with a set of “correct” or “reference” mappings that may be used by the generative output engine to learn how to correctly apply the natural language input to generate the components, including the automation components or rule clauses.

Prompt creation 246 includes the generation of the component-selection prompt (e.g., the selection of components other than the trigger(s)). Generally, the prompt (e.g., a message formatted to send to the generative output engine, for example via an API call) includes information about what is automation (e.g., what is an automation rule) and that the purpose of the prompt is to create automation rules. The trigger-selection prompt also includes a list of each automation rule component, and a description of the components. The trigger-selection prompt also includes a list of example prompts, and a correct output for the associated prompt. A function for the prompt creation 242 may be created to select components needed for the prompt. The function may take a list of components (e.g., a comma separated list of components), for example “PagePublishedTrigger,” “CQLCondition,” “AddLabelAction,” or another trigger, condition, action, or other component described herein. In some embodiments, prompt creation is performed with the identity of the automation rule components and their associated function (e.g., what the component does), but is in the absence of a configuration for one or more, or all, of the automation rule components.

Following prompt creation, the component-selection prompt (e.g., as a request message) may be sent to the generative output engine 238 via an API call. In some example, the generative output engine 238 may be internal to the system 100, and a request message may be sent via an API call for such generative output engine 238 that is internal, or the request message may be according to another message format or structure. Generative output engine 238 may process the component-selection prompt as described herein, and return a generative response, indicating one or more selected components for the natural language input of the automation rule.

In one or more embodiments, the returned generative response related to the component-selection prompt is subject to validation. In particular, the selected component or components, for example the selected automation components or rule clauses, may be validated to determine whether each automation components or rule clauses makes sense in the context of the applicable platform. For example, the selected automation components or rule clauses may be checked against a list of exemplary or allowed automation components and rule clauses. In some cases, the generative output engine 238 may “hallucinate” or otherwise erroneously create or fabricate triggers where none exists, or in violation of a rule of usage within the platform, and validation is used to prevent erroneous results.

Although shown as parallel, semi-independent (or fully-independent) processes for one or more embodiments, in some embodiments, trigger selection 233 and component selection 234 may be performed sequentially (e.g., 241-244 performed followed by 245-248). However, one or more of 241-244 may be performed after one or more of by 245-248. Additionally, or alternatively, one or more of 241-244 may be performed as a combined process with one or more of 245-248. For example, consistent with the disclosure provided herein, prompt creation 242 and prompt creation 246 may be a single prompt creation resulting in a single prompt for both trigger selection and component selection (e.g., the single prompt may include both parts of the trigger-selection prompt parts 241 and parts of the component-selection prompt parts 245). A single message for the generative output engine 238 may then be generated, and a single API call performed, resulting in one generative response. In some embodiments, there may then be one validation (e.g., a combined or joint selected trigger component validation and other selected component(s) validation 248).

In some embodiments, an error with one or more of the component-selection prompt or the trigger-selection prompt results in an erroneous output being returned from the generative output engine. In such case a request message from the prior prompt (e.g., the trigger-selection prompt or the component-selection prompt) can be included in a new prompt. However, a request message may be sent to client device 104 or client device 106 formatted to request information to fix the erroneous output. For example, during validation (e.g., one of selected trigger component validation 244 or other selected component(s) validation 248) the system 100 (e.g., by the centralized automation rule service 112 or the prompt management service 114), may detect one of the following: that the prompt has to trigger, the prompt has no action, there is not a corresponding component or trigger for a platform that supports the behavior indicated by the natural language rule, or the prompt is otherwise not intelligible (e.g., to the generative output engine). In response to the error, a GUI at a frontend interface (e.g., frontend interface 201 or a frontend interface 202) of system 100 may request a revision to the original natural language input. For example, an indication that a trigger is problematic and requesting a revised trigger may be displayed with a text entry field. Similarly, a request for a new action may be made. A message may also indicate that the prompt was not understood or not support and request a new natural language rule input. In some cases, just a portion of text may be requested. In other cases, the whole new natural language rule may be requested. In some examples, a proposed solution or set of solutions may be displayed to a user, and the user may confirm or reject the proposal, or select a proposed solution to use.

FIG. 2E depicts an example process flow 205 that supports automation rule creation for collaboration platforms, in accordance with aspects described herein. Process flow 205 includes operations that may be performed by system 100, which may also be referred to as a content collaboration system herein. In one or more embodiments, process flow 205 illustrates portions of rule generation 235, described herein.

In a particular example, process flow 205 takes as inputs the selected components that have been identified, for example during rule part selection 232 (including one or both of selected trigger component validation 244 or other selected component(s) validation 248). The selected components 251 are taken as inputs to the rule generation 253. Selected components 251 may include one or more selected triggers, one or more automation components or rule clauses, or some combination of these. In one or more embodiments, rule generation 253 only act on components that were previously selected, for example exclusive of the remaining components of the set of available trigger components of the automation trigger schemas, and exclusive of the non-selected one or more automation components or rule clauses. Process flow includes identifying the configuration information 252 for each of the selected components.

Based at least in part on the selected components 251 and configuration information 252, rule generation 253 is performed. In one or more embodiments, rule generation includes building a request in the form of an API call to a generative output engine 258, for example of a generative output service. In some embodiments, prompt creation 255 uses a list and description of selected components.

In one or more embodiments, prompt creation 255 includes generating a rule-selection prompt. In some embodiments, the rule-selection prompt includes at least a portion of the first generative response, at least a portion of the second generative response, and a set of example automation rules. For example, the rule-selection prompt (e.g., a message formatted to send to the generative output engine 258, for example via an API call) includes information about what is automation (e.g., what is an automation rule) and that the purpose of the prompt is to create automation rules. The rule-selection prompt may further include a list and description of the selected components, for example, including the selected trigger component (e.g., the one or more triggers associated with the generative response from the generative output engine, one or more automation components or rule clauses) and the other selected components.

In addition, the rule-selection prompt may include a list of examples during prompt creation 255. In some embodiments, the examples of the rule-selection prompt include example prompts, and the correct outputs for each corresponding prompt. In one or more embodiments, the example prompts are selected from a set of example prompts based on their relationship to the selected components. For example, each potential trigger, automation component, or rule clause may correspond to a set of example prompts. In some examples, each set of example prompts may be selected based on the observed frequency with which such example prompts result in correct automation rules. In some examples, providing a more limited set of example prompts (e.g., tailored to the selected components) may reduce costs (e.g., quantity of tokens) associated with utilizing the generative output service.

Additionally, in some embodiments, the rule-selection prompt may include smart values that are associated with the selected components. For examples if a page published trigger is selected, the page may have an extra message of the prompt that describes the page smart value. Additionally, or alternatively, in some embodiments, the rule-selection prompt may further include smart value data logic.

In some embodiments, the rule-selection prompt may further include a function to generate a rule for the prompt, the function taking a fully created automation rule in a format, such as a JSON format.

Following prompt creation 255, a call 256 to the generative output engine 258 is performed. In one or more embodiments, the system 100 provides the rule-selection prompt to the generative output engine using a an API call. Where two prior API calls to the generative output service have been made, call 256 may be the third API call. In some example, the generative output engine 258 may be internal to the system 100, and a request message may be sent via an API call for such generative output engine 258 that is internal, or the request message may be according to another message format or structure.

Generative output engine 258 may process the rule-selection prompt as described herein, and return a generative response. System 100 then obtains or otherwise receives a generative response (e.g., a third generative response) from the generative output engine responsive to the API call (e.g., a third API call). In one or more embodiments, the generative response returned by the generative output engine is an automation rule corresponding to the user's input natural language rule.

In one or more embodiments, the returned generative response related to the rule-selection prompt is subject to validation. In particular, the initial automated rule may be validated to determine whether each automation components or rule clauses makes sense in the context of the applicable platform. For example, the initial automated rule may be checked against a list of exemplary or allowed triggers, automation components, or rule clauses. In some cases, the generative output engine 258 may “hallucinate” or otherwise erroneously create or fabricate triggers, components, branches, rule clauses, and so on, where none exists, or in violation of a rule of usage within the platform, and validation is used to prevent erroneous results. In the case that the response is considered to be erroneous in some fashion, system 100 may cause a message to be displayed at a GUI, as further described herein.

FIG. 2F depicts an example process flow 205 that supports automation rule creation for collaboration platforms, in accordance with aspects described herein. Process flow 206 includes operations that may be performed by system 100, which may also be referred to as a content collaboration system herein. In one or more embodiments, process flow 206 illustrates portions of rule mapping 236, described herein.

In one or more embodiments, the generative output engine may output the initial automation rule in a format (e.g., a natural language format) that is insufficiently tailored or otherwise specific to the platform or platforms to which the automation rule is to be applied. As such, in one or more embodiments, rule mapping 236 includes resolving data to the full source of the data. For example, a user (e.g., as part of the natural language input) may provide only an object name (e.g., a space name), and rule mapping 236 may resolve the object name to a configuration or object that the automation rule acts on (e.g., a space key corresponding to that space name). As another example, the component may resolve a person's name (e.g., a partial name such as a last name or nickname) to an identified user of the platform (e.g., a specific user identifier).

At 263, each component is mapped to a real configuration. In one or more embodiments, the system 100 (e.g., the centralized automation rule service 112) attempts to identify one automation rule component for each part of the initial automation rule 261. For example, if the returned components of the initial automation rule include a trigger is that a space is archived, at 263, zero or more spaces of a platform are identified for the space of the initial automation rule. In some case, all returned components of the initial automation rule map to a single component of the one or more associated platforms. However, zero or two or more components may be identified.

At 264, the system 100 (e.g., the centralized automation rule service 112) components may be resolved to a single component for the automation rule. However, if one or more components resolve to zero or two or more components, the components are resolved to a single component.

At 265, real components are created. As user herein, real components may refer to those components that are meaningful or otherwise understandable to the application platform or platforms. For example, the component of the initial automation rule may be natural language, but the components understandable by the platform may need to adhere to a certain format and fall within an available set of components for that platform or conform to other rules of the platform (e.g., certain components may be required to precede other components, or certain components may be restricted for use with other components). The real components may also need to be formatted according to a set of rules, such that the automation rule is understandable programmatically by the components of system 100 to which the automation rule applies. For example, if the initial automation rule states “comment identifier” is to be deleted, this text may be mapped to “{{comment.id}}.”

Following real component creation 265, the final automation rule 266 is created.

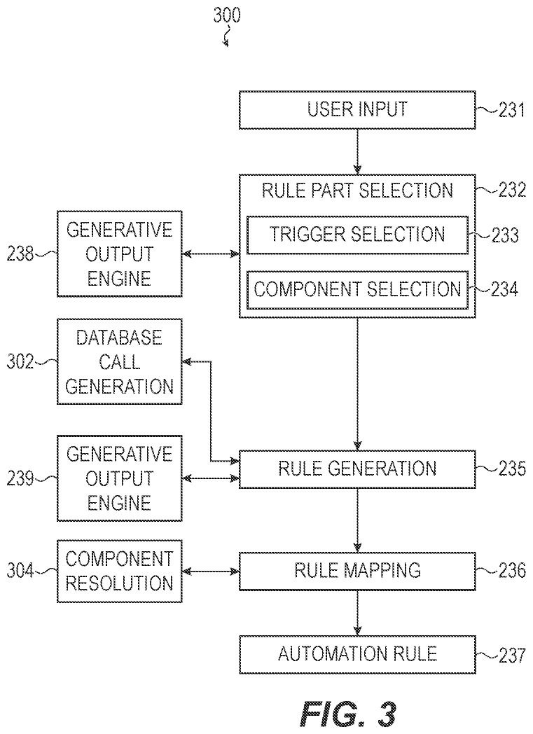

FIG. 3 depicts an example process flow 300 that supports automation rule creation for collaboration platforms, in accordance with aspects described herein. Process flow 300 includes operations that may be performed by system 100, which may also be referred to as a content collaboration system herein. In one or more embodiments, process flow includes one or more aspects of process flow 203, which may include one or more aspects of the process flows described with reference to FIGS. 2A-2F.

Process flow 300 includes database call generation 302. In some embodiments the automation rule sought to be generated uses different database call types. For example, if the automation rule uses a trigger from a first platform of the system 100, but an action in a second platform of the system 100 (or a third-party platform) using a different database, then the database call generation 302 may be necessary or desired for the automation rule. For example, one platform may be an issue tracking platform while the other platform is a documentation platform.

In one or more embodiments, database call generation includes analyzing the generative response (from rule generation 235) to identify that the natural language string or the generative response requires an external data reference, and identify a database associated with the external data reference. Database call generation 302 may then include reconfiguring an automation component or rule clause to add the identified database or use a database call type for the database. In some embodiments, reconfiguring the automation component or rule clause includes generating a database call-selection prompt that includes the automation component or rule clause, and a set of example database calls. The generated prompt is then provided to the generative output engine 239, for example using an API call. The generative output engine 239 can then produce a generative response responsive to the API call, where the generative response includes the automation component or rule clause and the second database call type.

Additionally, or alternatively, process flow 300 includes component resolution 304. In some cases, one or more components (e.g., an automation component or rule clause) is identified as corresponding to zero or two or more components. That is, the components are not unambiguous resolved to a single object.

In one or more embodiments, as part of rule mapping 236, the system 100 generates an automation rule with the object. If no objects are identified or returned, then system 100 may cause a user interface (e.g., a GUI of client device 104 or client device 106) to display one or more communications to the user. For example, the communication may be a request that the user check the identifier (e.g., a page title) for the object (e.g., a page of a document management system, or issue of an issue tracking system) for accuracy. In another example, the communication may be a request or option for the user to create an object according to that identifier (e.g., a page or issue with that title or other identifier). Alternatively, the user may select to cancel or retry the automation rule creation.

In one or more embodiments, as part of rule mapping 236, the system 100 generates an automation rule with two or more objects being identified or returned. System 100 may then cause a user interface (e.g., a GUI of client device 104 or client device 106) to display one or more communications to the user. The communication may identify or otherwise display information about the two or more objects, for example so that the user can check the identifier (e.g., a page title) for the object (e.g., a page of a document management system, or issue of an issue tracking system) against the two or more objects, or otherwise select one of the two objects as corresponding to the correct object. In another example, the communication may be a request or option for the user to create an object according to that identifier (e.g., a page or issue with that title or other identifier). Alternatively, the user may select to cancel or retry the automation rule creation.

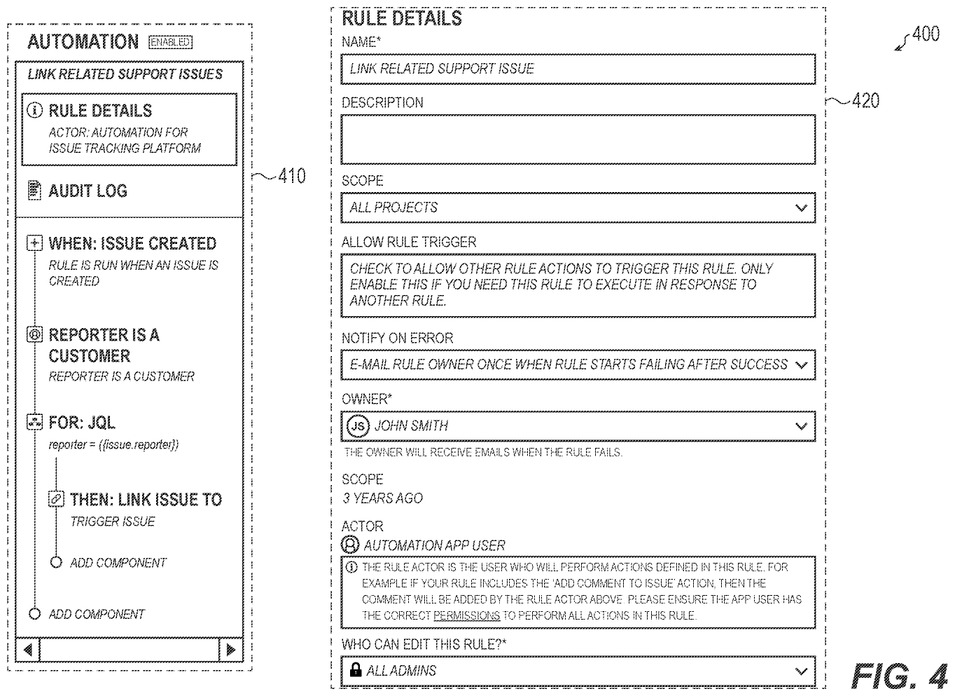

FIG. 4 depicts an example frontend interface 400 that supports automation rule creation for collaboration platforms, in accordance with aspects described herein. In some examples, frontend interface 400 is an example of frontend interface 201, and display one or more aspects of an exemplary automation rule generated according to a process flow performed by system 100, as further described herein (e.g., one or more of process flow 203, process flow 204, process flow 205, process flow 206, or process flow 300).

In an example for an issue tracking platform and a documentation platform, an automation rule may be created to auto-link support issues (e.g., from the issue tracking platform) from different people from the same compony (e.g., using information from the documentation platform). Such a rule may help avoid duplicate issues and provide better support.

The frontend interface 400 includes an automation rule area 410 that displays the components of the automation rule. In the example illustrated for frontend interface 400, the rule title 222a of the automation rule is “link related support issues”. The actor 222c in this example is “automation for the issue tracking platform,” but would typically be a particular user or group of users of the platform. In this example, the event trigger 222d is when the issue of the issue tracking platform is created, which has a trigger summary 222e which is displayed as “rule is run when an issue is created.” The event condition(s) 222f is that the reporter for the issue is a customer and the condition(s) summary 222g is displayed that the “reporter is a customer.” The action 222h in this example includes a call to a database for a platform of a first type (e.g., for an issue tracking platform), where the action object 222i is reporter={{issue.reporter}}, and the action 222h links the trigger issue (here, the issue that was create) to the reporter than is the customer.

Automation rule details 420 allow the user to specify additional details (e.g., by setting parameter values) regarding the automation rules, includes a name for the rule, description, scope, whether to allow other rules to trigger the rule, who to notify for errors, the owner, and permission (e.g., for editing). The automation rule details 420 can also display certain metadata, such as when the rule was created, or provide tips or help.

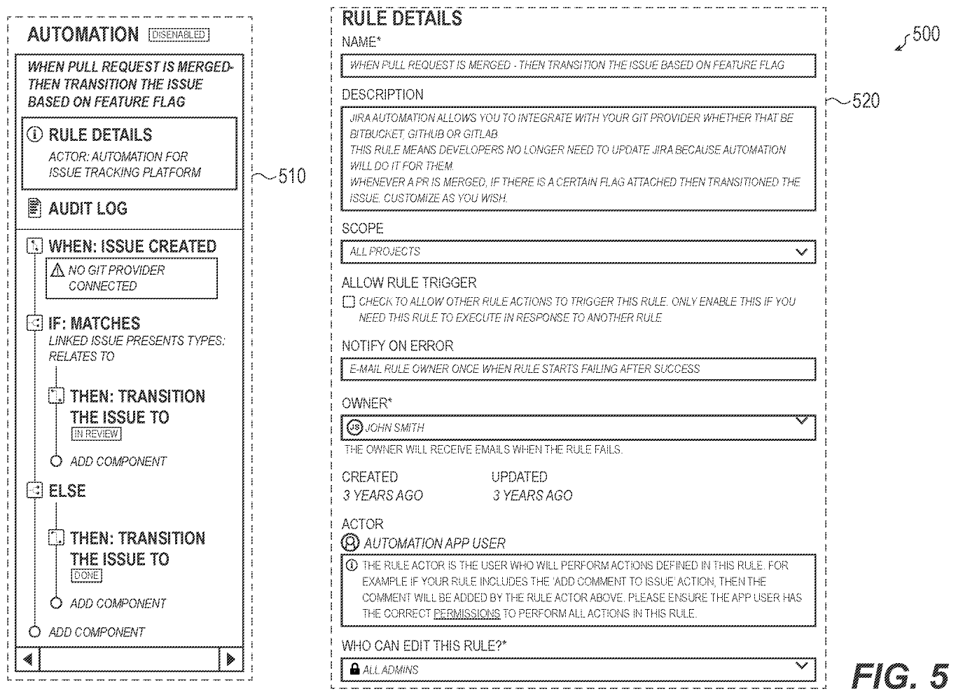

FIG. 5 depicts an example frontend interface 500 that supports automation rule creation for collaboration platforms, in accordance with aspects described herein. In some examples, frontend interface 500 is an example of frontend interface 201, and display one or more aspects of an exemplary automation rule generated according to a process flow performed by system 100, as further described herein (e.g., one or more of process flow 203, process flow 204, process flow 205, process flow 206, or process flow 300).

In an example for an issue tracking platform and a software development platform (e.g., a third-party software development platform), an automation rule may be created transition an issue (e.g., in the issue tracking platform) based on a pull request being merged (e.g., in the software development platform).

In the automation rule area 510 that displays the components of the automation rule. In the example illustrated for frontend interface 501, the rule title 222a of the automation rule is “when pull request is merged—then transition the issue based on feature flag”. The actor 222c in this example is “automation for the issue tracking platform,” but would typically be a particular user or group of users of the platform. In this example, the event trigger 222d is when the pull request is merged in the software development platform. In this case, the software development platform can be a third-party platform. The trigger summary 222e which is displayed as “when pull request merged.” The event condition(s) 222f is a match where the condition(s) summary 222g describes that the linked issue present types that relate to the issue. The action 222h in this example includes transitioning the issue to “in review” status for the second platform if there is a match. If there is no match for the event condition(s) 222f, then the issue is transitioned to “done” status for the second platform.

Automation rule details 520 allow the user to specify additional details (e.g., by setting parameter values) regarding the automation rules, includes a name for the rule, description, scope, whether to allow other rules to trigger the rule, who to notify for errors, the owner, and permission (e.g., for editing). The automation rule details 520 can also display certain metadata, such as when the rule was created, modified, or provide tips or help.

These foregoing embodiments depicted in FIGS. 2A-5 and the various alternatives thereof and variations thereto are presented, generally, for purposes of explanation, and to facilitate an understanding of various configurations and constructions of a system and related user interfaces and methods of interacting with those interfaces, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that a common editor frame is only one method of providing input to, and receiving output from, a generative output engine as described herein.

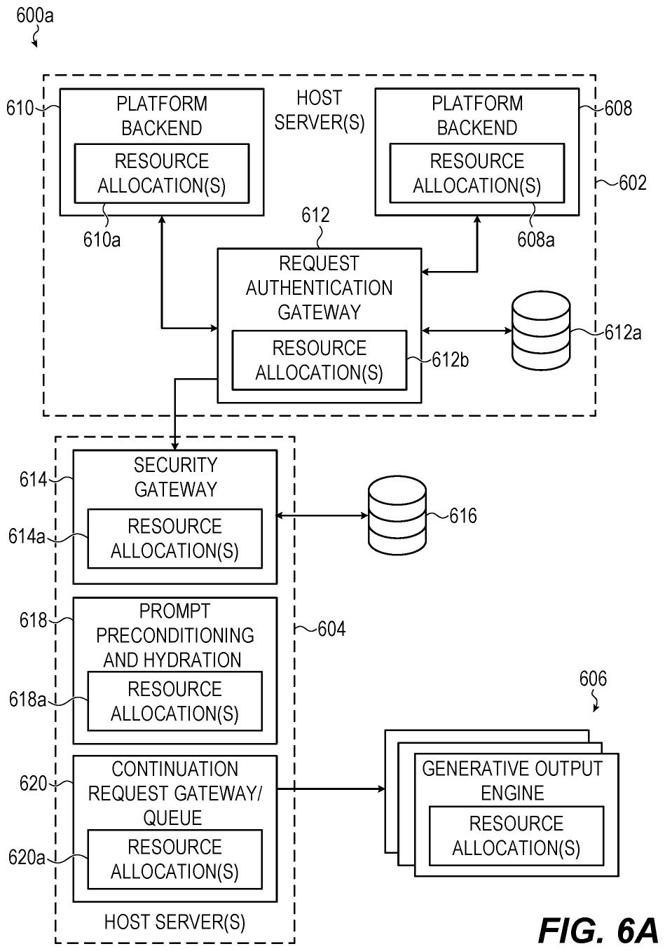

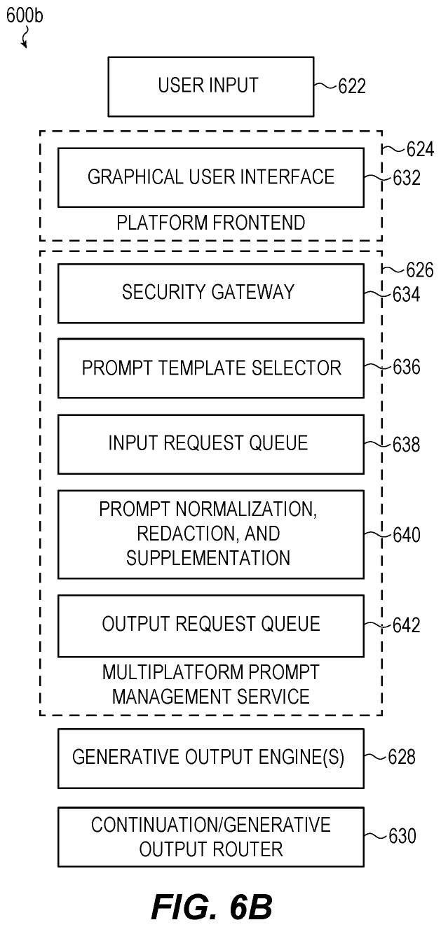

FIGS. 6A-6B depicts system diagrams and network/communication architectures that may support a system as described herein. Referring to FIG. 6A, the system 600a includes a first set of host servers 602 associated with one or more software platform backends. These software platform backends can be communicably coupled to a second set of host servers 604 purpose configured to process requests and responses to and from one or more generative output engines 606.

Specifically, the first set of host servers 602 (which, as described above can include processors, memory, storage, network communications, and any other suitable physical hardware cooperating to instantiate software) can allocate certain resources to instantiate a first and second platform backend, such as a first platform backend 608 and a second platform backend 610. Each of these respective backends can be instantiated by cooperation of processing and memory resources associated to each respective backend. As illustrated, such dedicated resources are identified as the resource allocations 608a and the resource allocations 610a.

Each of these platform backends can be communicably coupled to an authentication gateway 612 configured to verify, by querying a permissions table, directory service, or other authentication system (represented by the database 612a) whether a particular request for generative output from a particular user is authorized. Specifically, the second platform backend 610 may be a documentation platform used by a user operating a frontend thereof.

The user may not have access to information stored in an issue tracking system. In this example, if the user submits a request through the frontend of the documentation platform to the backend of the documentation platform that in any way references the issue tracking system, the authentication gateway 612 can deny the request for insufficient permissions. This example is merely one and is not intended to be limiting; many possible authorization and authentication operations can be performed by the authentication gateway 612. The authentication gateway 612 may be supported by physical hardware resources, such as a processor and memory, represented by the resource allocations 612b.

Once the authentication gateway 612 determines that a request from a user of either platform is authorized to access data or resources implicated in service that request, the request may be passed to a security gateway 614, which may be a software instance supported by physical hardware identified in FIG. 6A as the resource allocations 614a. The security gateway 614 may be configured to determine whether the request itself conforms to one or more policies or rules (data and/or executable representations of which may be stored in a database 616) established by the organization. For example, the organization may prohibit executing prompts for offensive content, value-incompatible content, personally identifying information, health information, trade secret information, unreleased product information, secret project information, and the like. In other cases, a request may be denied by the security gateway 614 if the prompt requests beyond a threshold quantity of data.

Once a particular user-initiated prompt has been sufficiently authorized and cleared against organization-specific generative output rules, the request/prompt can be passed to a preconditioning and hydration service 618 configured to populate request-contextualizing data (e.g., user ID, page ID, project ID, URLs, addresses, times, dates, date ranges, and so on), insert the user's request into a larger engineered template prompt and so on. Example operations of a preconditioning instance are described elsewhere herein; this description is not repeated. The preconditioning and hydration service 618 can be a software instance supported by physical hardware represented by the resource allocations 618a. In some implementations, the hydration service 618 may also be used to rehydrate personally identifiable information (PII) or other potentially sensitive data that has been extracted from a request or data exchange in the system.

One a prompt has been modified, replaced, or hydrated by the preconditioning and hydration service 618, it may be passed to an output gateway 620 (also referred to as a continuation gateway or an output queue). The output gateway 620 may be responsible for enqueuing and/or ordering different requests from different users or different software platforms based on priority, time order, or other metrics. The output gateway 620 can also serve to meter requests to the generative output engines 606.

FIG. 6B depicts a functional system diagram of the system 600a depicted in FIG. 6A. In particular, the system 600b is configured to operate as a multiplatform prompt management service supporting and ordering requests from multiple users across multiple platforms. In particular, a user input 622 may be received at a platform frontend 624. The platform frontend 624 passes the input to a prompt management service 626 that formalizes a prompt suitable for input to a generative output engine 628, which in turn can provide its output to an output router 660 that may direct generative output to a suitable destination. For example, the output router 660 may execute API requests generated by the generative output engine 628, may submit text responses back to the platform frontend 624, may wrap a text output of the generative output engine 628 in an API request to update a backend of the platform associated with the platform frontend 624, or may perform other operations.

Specifically, the user input 622 (which may be an engagement with a button, typed text input, spoken input, chat box input, and the like) can be provided to a graphical user interface 632 of the platform frontend 624. The graphical user interface 632 can be communicably coupled to a security gateway 634 of the prompt management service 626 that may be configured to determine whether the user input 622 is authorized to execute and/or complies with organization-specific rules.

The security gateway 634 may provide output to a prompt selector 636 which can be configured to select a prompt template from a database of preconfigured prompts, templatized prompts, or engineered templatized prompts. Once the raw user input is transformed into a string prompt, the prompt may be provided as input to a request queue 638 that orders different user request for input from the generative output engine 628. Output of the request queue 638 can be provided as input to a prompt hydrator 640 configured to populate template fields, add context identifiers, supplement the prompt, and perform other normalization operations described herein. In other cases, the prompt hydrator 640 can be configured to segment a single prompt into multiple discrete requests, which may be interdependent or may be independent.

Thereafter, the modified prompt(s) can be provided as input to an output queue at 642 that may serve to meter inputs provided to the generative output engine 628.

These foregoing embodiments depicted in FIG. 6A-6B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

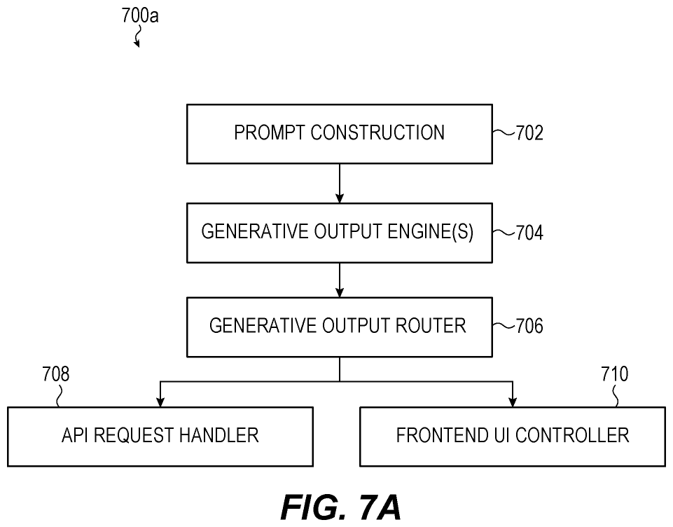

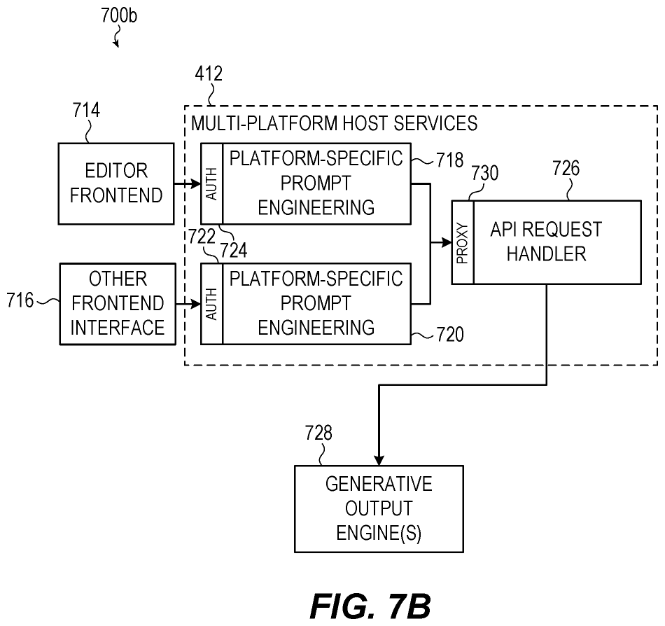

For example, although many constructions are possible, FIG. 7A depicts a simplified system diagram and data processing pipeline as described herein. The system 700a receives user input, and constructs a prompt therefrom at operation 702. After constructing a suitable prompt, and populating template fields, selecting appropriate instructions and examples for an LLM to continue, the modified constructed prompt is provided as input to a generative output engine 704. A continuation from the generative output engine 704 is provided as input to a router 706 configured to classify the output of the generative output engine 704 as being directed to one or more destinations. For example, the router 706 may determine that a particular generative output is an API request that should be executed against a particular API (e.g., such as an API of a system or platform as described herein). In this example, the router 706 may direct the output to an API request handler 708. In another example, the router 706 may determine that the generative output may be suitably directed to a graphical user interface/frontend. For example, a generative output may include suggestions to be shown to a user below a user's partial input, such as shown in FIGS. 2A-2B.

Another example architecture is shown in FIG. 7B, illustrating a system providing prompt management, and in particular multiplatform prompt management as a service. The system 700b is instantiated over cloud resources, which may be provisioned from a pool of resources in one or more locations (e.g., datacenters). In the illustrated embodiment, the provisioned resources are identified as the multi-platform host services 712.

The multi-platform host services 712 can receive input from one or more users in a variety of ways. For example, some users may provide input via an editor region 714 of a frontend, such as described above. Other users may provide input by engaging with other user interface elements 716 unrelated to common or shared features across multiple platforms. Specifically, the second user may provide input to the multi-platform host services 712 by engaging with one or more platform-specific user interface elements. In yet further examples, one or more frontends or backends can be configured to automatically generate one or more prompts for continuation by generative output engines as described herein. More generally, in many cases, user input may not be required and prompts may be requested and/or engineered automatically.

The multi-platform host services 712 can include multiple software instances or microservices each configured to receive user inputs and/or proposed prompts and configured to provide, as output, an engineered prompt. In many cases, these instances—shown in the figure as the platform-specific prompt engineering services 718, 720—can be configured to wrap proposed prompts within engineered prompts retrieved from a database such as described above.

In many cases, the platform-specific prompt engineering services 718, 720 can be each configured to authenticate requests received from various sources. In other cases, requests from editor regions or other user interface elements of particular frontends can be first received by one or more authenticator instances, such as the authentication instances 722, 724. In other cases, a single centralized authentication service can provide authentication as a service to each request before it is forwarded to the platform-specific prompt engineering services 718, 720.

Once a prompt has been engineered/supplemented by one of the platform-specific prompt engineering services 718, 720, it may be passed to a request queue/API request handler 726 configured to generate an API request directed to a generative output engine 728 including appropriate API tokens and the engineered prompt as a portion of the body of the API request. In some cases, a service proxy 730 can interpose the platform-specific prompt engineering services 718, 720 and the request queue/API request handler 726, so as to further modify or validate prompts prior to wrapping those prompts in an API call to the generative output engine 728 by the request queue/API request handler 726 although this is not required of all embodiments.

These foregoing embodiments depicted in FIG. 3A-3B and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

More generally, it may be appreciated that a system as described herein can be used for a variety of purposes and functions to enhance functionality of collaboration tools. Detailed examples follow. Similarly, it may be appreciated that systems as described herein can be configured to operate in a number of ways, which may be implementation specific.

For example, it may be appreciated that information security and privacy can be protected and secured in a number of suitable ways. For example, in some cases, a single generative output engine or system may be used by a multiplatform collaboration system as described herein. In this architecture, authentication, validation, and authorization decisions in respect of business rules regarding requests to the generative output engine can be centralized, ensuring auditable control over input to a generative output engine or service and auditable control over output from the generative output engine. In some constructions, authentication to the generative output engine's services may be checked multiple times, by multiple services or service proxies. In some cases, a generative output engine can be configured to leverage different training data in response to differently-authenticated requests. In other cases, unauthorized requests for information or generative output may be denied before the request is forwarded to a generative output engine, thereby protecting tenant-owned information within a secure internal system. It may be appreciated that many constructions are possible.

Additionally, some generative output engines can be configured to discard input and output one a request has been serviced, thereby retaining zero data. Such constructions may be useful to generate output in respect of confidential or otherwise sensitive information. In other cases, such a configuration can enable multi-tenant use of the same generative output engine or service, without risking that prior requests by one tenant inform future training that in turn informs a generative output provided to a second tenant. Broadly, some generative output engines and systems can retain data and leverage that data for training and functionality improvement purposes, whereas other systems can be configured for zero data retention.

In some cases, requests may be limited in frequency, total number, or in scope of information requestable within a threshold period of time. These limitations (which may be applied on the user level, role level, tenant level, product level, and so on) can prevent monopolization of a generative output engine (especially when accessed in a centralized manner) by a single requester. Many constructions are possible.

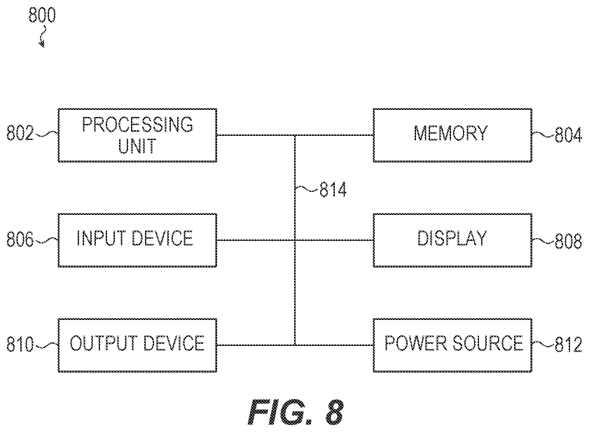

FIG. 8 shows a sample electrical block diagram of an electronic device 800 that may perform the operations described herein. The electronic device 800 may in some cases take the form of any of the electronic devices described with reference to FIGS. 1-5, including client devices, and/or servers or other computing devices associated with the system 100. The electronic device 800 can include one or more of a processing unit 802, a memory 804 or storage device, input devices 806, a display 808, output devices 810, and a power source 812. In some cases, various implementations of the electronic device 800 may lack some or all of these components and/or include additional or alternative components.

The processing unit 802 can control some or all of the operations of the electronic device 800. The processing unit 802 can communicate, either directly or indirectly, with some or all of the components of the electronic device 800. For example, a system bus or other communication mechanism 814 can provide communication between the processing unit 802, the power source 812, the memory 804, the input device(s) 806, and the output device(s) 810.

The processing unit 802 can be implemented as any electronic device capable of processing, receiving, or transmitting data or instructions. For example, the processing unit 802 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 800 can be controlled by multiple processing units. For example, select components of the electronic device 800 (e.g., an input device 806) may be controlled by a first processing unit and other components of the electronic device 800 (e.g., the display 808) may be controlled by a second processing unit, where the first and second processing units may or may not be in communication with each other.

The power source 812 can be implemented with any device capable of providing energy to the electronic device 800. For example, the power source 812 may be one or more batteries or rechargeable batteries. Additionally, or alternatively, the power source 812 can be a power connector or power cord that connects the electronic device 800 to another power source, such as a wall outlet.

The memory 804 can store electronic data that can be used by the electronic device 800. For example, the memory 804 can store electronic data or content such as, for example, audio and video files, documents and applications, device settings and user preferences, timing signals, control signals, and data structures or databases. The memory 804 can be configured as any type of memory. By way of example only, the memory 804 can be implemented as random access memory, read-only memory, flash memory, removable memory, other types of storage elements, or combinations of such devices.

In various embodiments, the display 808 provides a graphical output, for example associated with an operating system, user interface, and/or applications of the electronic device 800 (e.g., a chat user interface, an issue-tracking user interface, an issue-discovery user interface, etc.). In one embodiment, the display 808 includes one or more sensors and is configured as a touch-sensitive (e.g., single-touch, multi-touch) and/or force-sensitive display to receive inputs from a user. For example, the display 808 may be integrated with a touch sensor (e.g., a capacitive touch sensor) and/or a force sensor to provide a touch- and/or force-sensitive display. The display 808 is operably coupled to the processing unit 802 of the electronic device 800.

The display 808 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 808 is positioned beneath and viewable through a cover that forms at least a portion of an enclosure of the electronic device 800.

In various embodiments, the input devices 806 may include any suitable components for detecting inputs. Examples of input devices 806 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 806 may be configured to detect one or more particular types of input and provide a signal (e.g., an input signal) corresponding to the detected input. The signal may be provided, for example, to the processing unit 802.

As discussed above, in some cases, the input device(s) 806 include a touch sensor (e.g., a capacitive touch sensor) integrated with the display 808 to provide a touch-sensitive display. Similarly, in some cases, the input device(s) 806 include a force sensor (e.g., a capacitive force sensor) integrated with the display 808 to provide a force-sensitive display.

The output devices 810 may include any suitable components for providing outputs. Examples of output devices 810 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 810 may be configured to receive one or more signals (e.g., an output signal provided by the processing unit 802) and provide an output corresponding to the signal.

In some cases, input devices 806 and output devices 810 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 802 may be operably coupled to the input devices 806 and the output devices 810. The processing unit 802 may be adapted to exchange signals with the input devices 806 and the output devices 810. For example, the processing unit 802 may receive an input signal from an input device 806 that corresponds to an input detected by the input device 806. The processing unit 802 may interpret the received input signal to determine whether to provide and/or change one or more outputs in response to the input signal. The processing unit 802 may then send an output signal to one or more of the output devices 810, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A computer-implemented method for automation rule creation within a content collaboration system, the method comprising:
causing generation of a graphical user interface of the content collaboration system, the graphical user interface including an input field for receiving user input;
in response to receiving a natural language string at the input field of the graphical user interface:
generating a trigger-selection prompt comprising at least a first portion of the natural language string, a set of example automation trigger schemas, and a set of example input-output natural language to trigger pairs;
generating a component-selection prompt comprising at least a second portion of the natural language string, a set of example automation components or rule clauses, and a set of example input-output natural language to automation component or rule clause pairs;
providing the trigger-selection prompt to a generative output engine using a first application program interface call;
obtaining a first generative response from the generative output engine responsive to the first application program interface call;
providing the component-selection prompt to the generative output engine using a second application program interface call;
obtaining a second generative response from the generative output engine responsive to the second application program interface call;
generating a rule-selection prompt comprising at least a portion of the first generative response, at least a portion of the second generative response, and a set of example automation rules;
providing the rule-selection prompt to the generative output engine using a third application program interface call;
obtaining a third generative response from the generative output engine responsive to the third application program interface call;
identifying, based at least in part on the third generative response, one or more triggers, at least one automation component or rule clause, and an object identifier; and
generating a service on the content collaboration system that performs an operation in response to an event satisfying the one or more triggers, wherein the operation corresponds to the at least one automation component or rule clauses, and the operation is performed on a set of objects selected using the object identifier.

2. The computer-implemented method of claim 1, further comprising:
analyzing the third generative response to identify that the natural language string or the third generative response requires an external data reference;
identifying a database associated with the external data reference; and
reconfiguring the at least one automation component or rule clause to add the identified database or use a database call type for the database.

3. The computer-implemented method of claim 2, wherein reconfiguring the at least one automation component or rule clause to use the database call type comprises:
generating a database call-selection prompt comprising the at least one automation component or rule clause, and a set of example database calls;
providing the database call-selection prompt to the generative output engine using a fourth application program interface call; and
obtaining a fourth generative response from the generative output engine responsive to the fourth application program interface call, the fourth generative response comprising the at least one automation component or rule clause using the database call type.

4. The computer-implemented method of claim 1, further comprising:
determining that at least one initial configuration of the at least one automation component or rule clause is incomplete;
providing, to a platform backend, a call requesting information to complete the at least one initial configuration; and
obtaining, from the platform backend, a revised configuration for the at least one automation component or rule clause.

5. The computer-implemented method of claim 1, further comprising:
identifying that at least one initial configuration is associated with zero pages for a platform backend, or a plurality of pages for the platform backend;
providing, to the graphical user interface, a request for input to resolve the zero pages or the plurality of pages to be one page of the platform backend; and
obtaining the input at the graphical user interface in response to the request for input, wherein the generation of the service is based at least in part on the input.

6. The computer-implemented method of claim 1, wherein the trigger-selection prompt further comprises a description of each trigger of the set of example automation trigger schemas.

7. The computer-implemented method of claim 1, wherein the component-selection prompt further comprises a description of each automation component or rule clause of the set of example automation components or rule clauses.

8. The computer-implemented method of claim 1, wherein the rule-selection prompt further comprises a first description of the first generative response, and a second description of the second generative response.

9. The computer-implemented method of claim 1, wherein the rule-selection prompt further comprises a statement that a purpose of the generative output engine is to generate an automation rule in response to the rule-selection prompt.

10. The computer-implemented method of claim 1, wherein the graphical user interface is a first graphical user interface, and the input field is a first input field, the method further comprising:
determining that one or more of the trigger-selection prompt or the component-selection prompt has one or more errors; and
causing generation of a second graphical user interface of the content collaboration system, the second graphical user interface including an indication of the one or more errors and a second input field for receiving user input to resolve the one or more errors.

11. The computer-implemented method of claim 1, wherein the generative output engine is external to the content collaboration system.

12. The computer-implemented method of claim 1, wherein the generative output engine is at least a portion of the content collaboration system.

13. The computer-implemented method of claim 1, wherein the at least one automation component or rule clause comprises one or more of page archiving, page ownership changing, page status changing, page copying, page deletion, page moving, new page publishing, page restriction, blog deletion, comment addition, label addition, label removal, watcher management, space permission addition, space archiving, custom variable creation, issue assignment, issue cloning, issue comment addition, issue creation, sub-task creation, variable creation, comment deletion, issue deletion, issue editing, issue linking, work logging, issue lookup, watcher management, issue transition, email sending, message sending, text message sending, outgoing web request sending, service desk customer addition, service desk request creation, version creation, version release, attachment deletion, action logging, issue data re-fetching, entity property setting, event publishing, or an action with a third party platform external to the content collaboration system.

14. A content collaboration system, comprising:
a first interface configured to communicate with at least one client device;
a second interface configured to communicate with a generative output engine; and
a centralized automation rule service coupled with the first interface and the second interface, the centralized automation rule service configured to:
cause generation, via the first interface, of a graphical user interface at a client device of the at least one client device, the graphical user interface including an input field for receiving user input;
receive, via the first interface, a natural language string at the input field of the graphical user interface;
in response to receiving the natural language string, provide, via the second interface, a trigger-selection prompt to the generative output engine using a first application program interface call, the trigger-selection prompt including at least a first portion of the natural language string, a set of example automation trigger schemas, and a set of example input-output natural language to trigger pairs;
obtain, via the second interface, a first generative response from the generative output engine responsive to the trigger-selection prompt;
in response to receiving the natural language string, provide, via the second interface, a component-selection prompt to the generative output engine using a second application program interface call, the component-selection prompt including at least a second portion of the natural language string, a set of example automation components or rule clauses, and a set of example input-output natural language to automation component or rule clause pairs;
obtain, via the second interface, a second generative response from the generative output engine responsive to the component-selection prompt;
in response to obtaining the first generative response and the second generative response, provide, via the second interface, a rule-selection prompt to the generative output engine using a third application program interface call, the rule-selection prompt including at least a portion of the first one or more generative responses, and a set of example automation rules;
obtain, via the second interface, a third generative response from the generative output engine responsive to the rule-selection prompt;
in response to obtaining the third generative response from the generative output engine, identifying a trigger, at least one automation component or rule clause, and an object identifier:
generate a service that performs an operation in response to an event satisfying the trigger, the operation corresponding to the at least one automation component or rule clause;
detect that the event satisfying the trigger has occurred; and
perform the operation on a set of objects selected using the object identifier.

15. The content collaboration system of claim 14, further comprising:
a first database coupled with the centralized automation rule service, the centralized automation rule service further configured to:
analyze the third generative response to identify that the natural language string or the third generative response require an external data reference;
identify a second database associated with the external data reference; and
reconfigure the at least one automation component or rule clause to add the identified second database or use a database call type for the second database.

16. The content collaboration system of claim 15, wherein the centralized automation rule service configured to reconfigure the at least one automation component or rule clause comprises the centralized automation rule service configured to:
generate a database call-selection prompt comprising the at least one automation component or rule clause, and a set of example database calls;
provide, to the generative output engine, the database call-selection prompt using a fourth application program interface call; and
obtain, from the generative output engine, a fourth generative response responsive to the fourth application program interface call, the fourth generative response comprising the at least one automation component or rule clause using a second database call type.

17. The content collaboration system of claim 14, comprising:
a platform backend coupled with the centralized automation rule service and the first interface, the centralized automation rule service further configured to:
determine that at least one initial configuration of the at least one automation component or rule clause is incomplete;
provide, to the platform backend, a call requesting information to complete the at least one initial configuration; and
obtain, from the platform backend, a revised configuration for the at least one automation component or rule clause.

18. A computer-implemented method for automation rule creation within a content collaboration platform, the method comprising:
in response to receiving a natural language string at an input field of a graphical user interface at a client device, providing a trigger-selection prompt and a component-selection prompt to a generative output engine, the trigger-selection prompt including at least a first portion of the natural language string and one or more trigger-selection criteria, and the component-selection prompt including at least a second portion of the natural language string and one or more component-selection criteria;
in response to obtaining a first one or more generative responses from the generative output engine responsive to the trigger-selection prompt and the component-selection prompt, providing a rule-selection prompt to the generative output engine, the rule-selection prompt including at least a portion of the first one or more generative responses and one or more rule-selection criteria;
obtaining a second one or more generative responses from the generative output engine responsive to the rule-selection prompt;
in response to obtaining the second one or more generative responses, identifying a trigger, at least one automation component or rule clause, and an object identifier;
generating a service to perform an operation in response to an event satisfying the trigger;
detecting that the event satisfying the trigger has occurred; and
performing the operation on a set of objects selected using the object identifier.

19. The computer-implemented method of claim 18, wherein the one or more trigger-selection criteria comprise a set of example automation trigger schemas and a set of example input-output natural language to trigger pairs.

20. The computer-implemented method of claim 18, wherein the one or more component-selection criteria comprise a set of example automation components or rule clauses and a set of example input-output natural language to automation component or rule clause pairs.

21. The computer-implemented method of claim 18, wherein the one or more rule-selection criteria comprise a set of example automation rules.
